(19) United States
(12) Patent Application Publication
(10) Pub. No.: US 2023/0344871 A1
(43) Pub. Date: Oct. 26, 2023

(54) SECURE AND ATTESTABLE FUNCTIONS-AS-A-SERVICE

(71) Applicant: Intel Corporation, Santa Clara, CA (US)

(72) Inventors: Ned M. Smith, Beaverton, OR (US); Francesc Guim Bernat, Barcelona (ES); Sunil Cheruvu, Tempe (AZ); Kshitij Arun Doshi, Tempe, AZ (US); Marcos E. Carranza, Portland, OR (US)

(21) Appl. No.: 18/216,412

(22) Filed: Jun. 29, 2023

(51) Int. Cl. H04L 9/40; H04L 67/60

(52) U.S. Cl. CPC H04L 63/20; H04L 67/60

(57) ABSTRACT

Software and other electronic services are increasingly being executed in cloud computing environments. Edge computing environments may be used to bridge the gap between cloud computing environments and end-user software and electronic devices, and may implement Functions-as-a-Service (FaaS). FaaS may be used to create flavors of particular services, a chain of related functions that implements all or a portion of a FaaS edge workflow or workload. A FaaS Temporal Software-Defined Wide-Area Network (SD-WAN) may be used to receive a computing request and decompose the computing request into several FaaS flavors, enable dynamic creation of SD-WANs for each FaaS flavor, execute the FaaS flavors in their respective SD-WAN, return a result, and destroy the SD-WANs. The FaaS Temporal SD-WAN expands upon current edge systems by allowing low-latency creation of SD-WAN virtual networks bound to a set of function instances that are created to a execute a particular service request.

### BACKGROUND

Software and other electronic services are increasingly being executed in cloud computing environments (e.g., in “the Cloud”). Edge computing environments (e.g., internet of things (IOT), Telco Edge, Enterprise Edge) may be used to bridge the gap between cloud computing environments and end-user software and electronic devices, providing improved performance, reduced bandwidth, and reduced latency. Edge computing environments may implement Functions-as-a-Service (FaaS), which may provide serverless computing environments for individual application functions. However, while FaaS provides service-based access to application functions, these remotely managed services may limit customization of application functionality. What is needed is a FaaS environment that provides improved application functionality customization.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating a FaaS envelope, according to an embodiment;

FIG. 2 is a block diagram illustrating a FaaS chain distribution, according to an embodiment;

FIG. 3 is a block diagram illustrating a FaaS Temporal Software-Defined Wide-Area Network (FaaS Temporal SD-WAN), according to an embodiment;

FIG. 4 is a block diagram illustrating a multiple tenant SD-WAN workflow, according to an embodiment;

FIG. 5 is a block diagram illustrating paging tenant security contexts, according to an embodiment;

FIG. 6 is a block diagram illustrating tenant-specific FaaS flavor chain on-demand paging, according to an embodiment;

FIG. 7 is a block diagram illustrating FaaS SD-WAN components, according to an embodiment;

FIG. 8 is a flow diagram illustrating a method for secure and attestable functions-as-a-service, according to an embodiment;

FIGS. 9A and 9B provide an overview of example components within a computing device in an edge computing system, according to an embodiment;

FIG. 10 is a block diagram showing an overview of a configuration for edge computing, according to an embodiment;

FIG. 11 illustrates operational layers among endpoints, an edge cloud, and cloud computing environments, according to an embodiment;

FIG. 12 illustrates an example approach for networking and services in an edge computing system, according to an embodiment;

FIG. 13 illustrates an example software distribution platform to distribute software, according to an embodiment; and

FIG. 14 depicts an example of an Infrastructure Processing Unit (IPU), according to an embodiment.

### DETAILED DESCRIPTION

FaaS may be used to create flavors of particular services, where FaaS Flavors conceptually are a chain (e.g., directed graph) of related functions that implements all or a portion of a FaaS edge workflow or workload. In an example, a FaaS flavor focusing on surveillance may be developed based on system requirements (e.g., a number of images to be processed), customer requirements (e.g., requirement to identify threat within one second), a number of resources in the edge computing platform (e.g., eight processing cores and one field-programmable gate array (FPGA)). The serverless operation of FaaS and tailoring of FaaS flavors may improve development, deployment, and execution of applications, particularly in edge computing environments.

In the following description, for purposes of explanation, numerous specific details are set forth in order to provide a thorough understanding of some example embodiments. It will be evident, however, to one skilled in the art that the present disclosure may be practiced without these specific details.

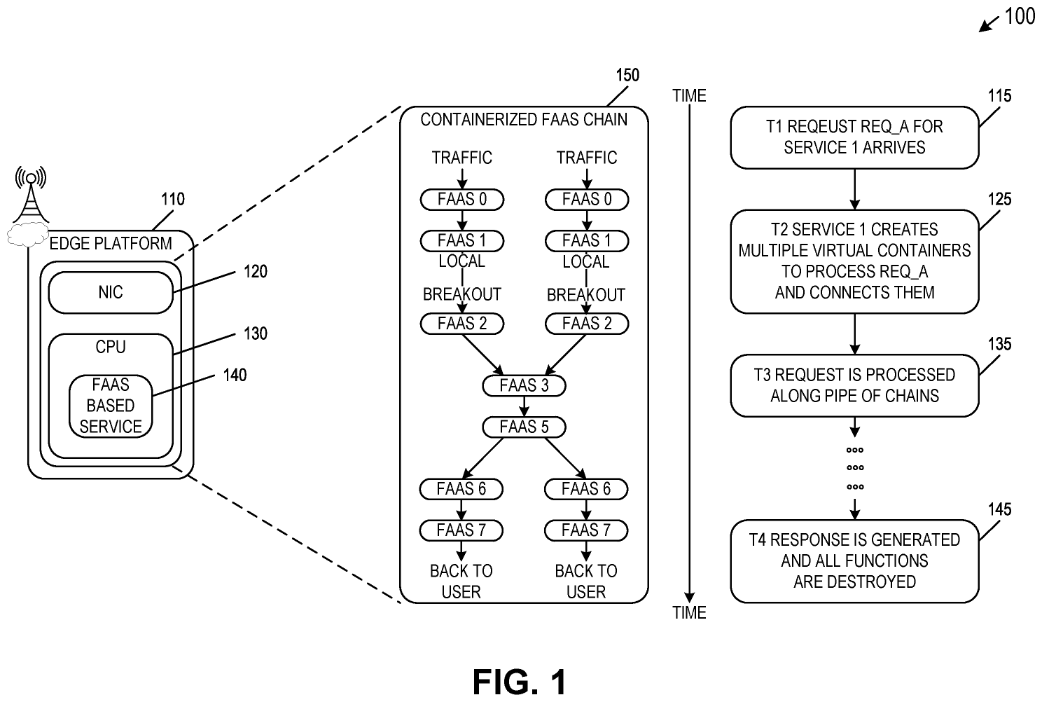

FIG. 1 is a block diagram illustrating a FaaS envelope 100, according to an embodiment. FaaS envelope 100 includes an edge platform 110, which may include a network interface card (NIC) 120 and a central processing unit (CPU) 130 to execute a FaaS-based service 140. The edge platform 110 may be used to bundle software files into a virtual container, such as FaaS chain container 150. The FaaS chain container 150 may be used to execute several functions within the FaaS chain. Each FaaS within the FaaS chain container 150 may include one or more virtual containers to implement and execute each FaaS.

In operation of the FaaS envelope 100, at a first time 115, a computing request may be received at the edge platform 110 for a first service. At second time 125, the edge platform 110 may create one or more virtual containers (e.g., FaaS chain container 150), create the corresponding functions needed to process the computing request, and connect the containers to process the computing request. At third time 135, the edge platform 110 may execute the functions across the virtual containers. At fourth time 145, the edge platform 110 may return the result of the execution of the functions and destroy the virtual containers (e.g., destroy FaaS chain container 150) or remove any sensitive data for the requesting party. The container destruction or sensitive data sanitization may provide improved privacy or data integrity for the requesting party, particularly when various components within the edge platform 110 may be reused by other requesting parties between computing requests. The execution of the FaaS chain container 150 within edge platform 110 (e.g., within a single domain) may be used to provide further data security and function isolation, such as using hardware virtualization features such as Intel Virtualization Technology for Directed Input/Output (VT-d), Intel Software Guard Extensions (SGX), Intel Trust Domain Extensions (TDX), or other hardware virtualization features.

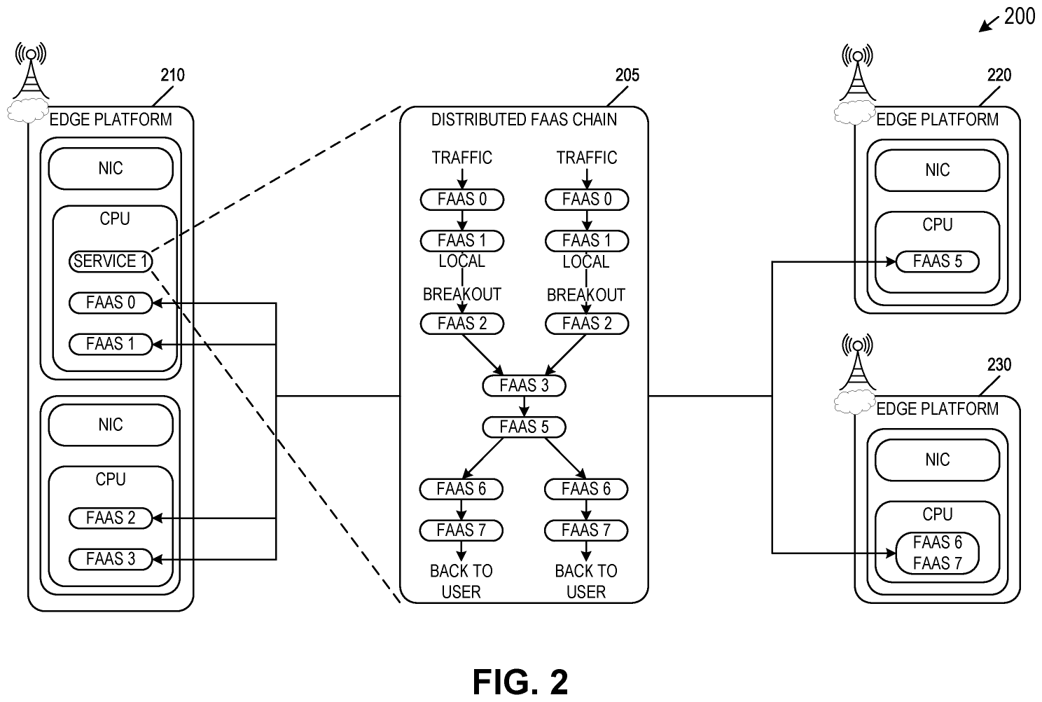

FIG. 2 is a block diagram illustrating a FaaS chain distribution 200, according to an embodiment. While FaaS envelope 100 may be used to execute a FaaS chain container 150 within a single edge domain, FaaS chain distribution 200 may be used to execute a distributed FaaS chain 205 across multiple edge platforms. The distributed FaaS chain 205 may be initialized as a service on a first CPU within a first edge platform 210, and may distribute functions across other CPUs and other edge platforms (e.g., edge platform 220 and edge platform 230). Each FaaS within the distributed FaaS chain 205 may include one or more virtual containers to implement and execute each FaaS. In the example shown in FIG. 2, the distributed FaaS chain 205 executes a first and second FaaS on a first CPU on the first edge platform 210, executes a third and fourth FaaS on a second CPU on the same first edge platform 210, executes a fifth FaaS on a CPU on a second edge platform 220, and executes a sixth and seventh FaaS on a CPU on the third edge platform 230. The functions may be distributed according to capabilities of various edge platforms to execute one or more of the FaaS requests within the distributed FaaS chain 205. For example, the CPU on the second edge platform 220 may be particularly suited for rapid execution of the fifth FaaS.

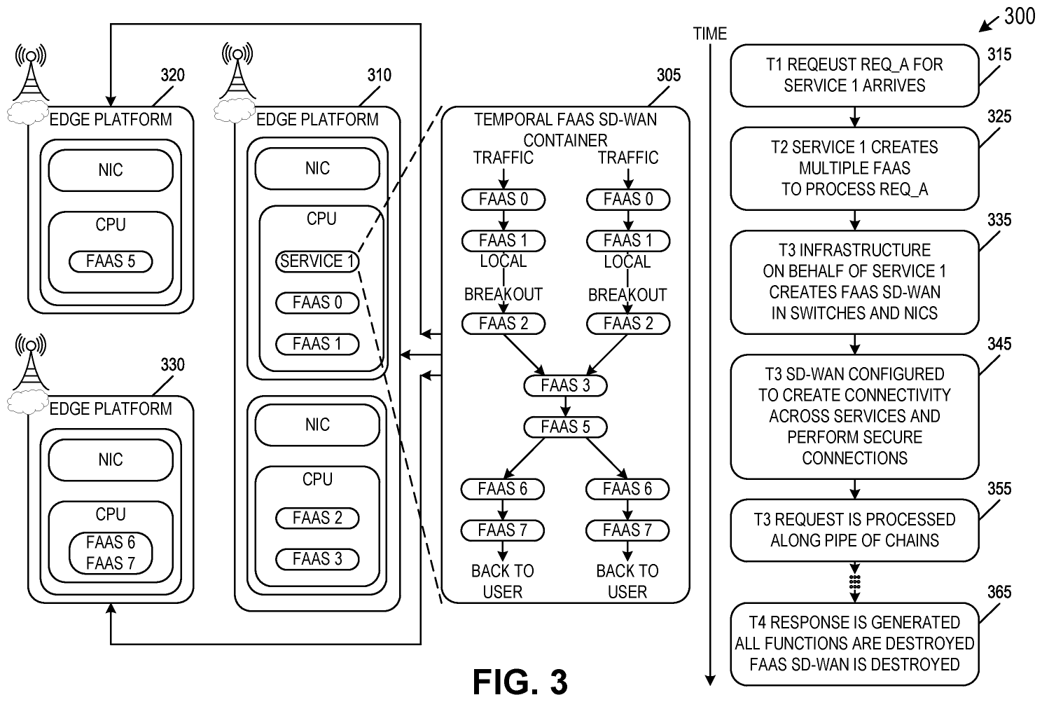

FIG. 3 is a block diagram illustrating a FaaS Temporal Software-Defined Wide-Area Network (FaaS Temporal SD-WAN) 300, according to an embodiment. The FaaS Temporal SD-WAN 300 may be used to receive a computing request and decompose the computing request into several FaaS flavors (e.g., chain of related functions) that implement one or more FaaS, such as the FaaS shown in temporal FaaS SD-WAN container 305. The FaaS Temporal SD-WAN 300 may then enable dynamic creation of SD-WANs (e.g., virtual networks) for execution of one or more FaaS flavors, execute the FaaS flavors in their respective SD-WAN, return a result, and optionally destroy the SD-WANs. The FaaS Temporal SD-WAN 300 expands upon current edge systems by allowing low-latency creation of SD-WAN virtual networks bound to a set of function instances that are created to a execute a particular service request.

In the example shown in FIG. 3, FaaS Temporal SD-WAN 300 may dynamically create a first SD-WAN on a first CPU of a first edge platform 310, create a second SD-WAN on a second CPU of the first edge platform 310, create a third SD-WAN on a CPU on a second edge platform 320, and create a fourth SD-WAN on a CPU on a third edge platform 330. Each SD-WAN may be associated with a set of services that belong to a common instance of a particular service for a particular customer request, such as the various FaaS within the temporal FaaS SD-WAN container 305.

In operation of the FaaS Temporal SD-WAN 300, at a first time 315, a computing request may be received at the first edge platform 310 for a first service. At a second time 325, the first service at the first edge platform 310 may identify and create multiple FaaS to process the computing request, such as the FaaS flavor chains shown in temporal FaaS SD-WAN container 305. At a third time 335, the edge platform infrastructure may, on the behalf of the service running at the first edge platform 310, create FaaS SD-WANs in various switches and NICs, such as within first edge platform 310, second edge platform 320, and third edge platform 330. In an example, the edge platform infrastructure includes a WAN controller to create and link edge platforms within a private WAN to provide the temporal distributed FaaS pipeline.

At a fourth time 345, each created SD-WAN may be configured to enable connectivity across multiple services and initiate secure connections, such as secure connections among first edge platform 310, second edge platform 320, and third edge platform 330. Once the secure connections are established, at fifth time 355, the sequence of FaaS requests (e.g., as indicated in temporal FaaS SD-WAN container 305) may be processed across the chain of SD-WANs. Upon completion of the sequence of FaaS requests, at sixth time 365, computing request response is generated, and the virtual implementations of the functions and SD-WANs are destroyed.

For each SD-WAN created by the FaaS Temporal SD-WAN 300, hardware acceleration may be used to improve the efficiency of the creation and configuration of each SD-WAN. In an example, hardware acceleration may be used to create and configure each SD-WAN within microseconds (e.g., in less than ten microseconds). The FaaS Temporal SD-WAN 300 may also provide mechanisms to enable each function (e.g., each FaaS) to discover and attest other created functions within a given SD-WAN, while providing isolation between any two SD-WANs.

Additional security may be used to provide improved protection of transient data used within the temporal FaaS SD-WAN container 305. For each FaaS flavor, the FaaS flavor may be examined to determine an appropriate cryptographic scheme, and each SD-WAN may be generated using that cryptographic scheme. This cryptographic administration of FaaS flavors may improve the ability of the FaaS Temporal SD-WAN 300 to configure SD-WANs such that the output of each FaaS function is pipelined efficiently into the next FaaS function for optimal performance.

The FaaS Temporal SD-WAN 300 may provide further security improvements by managing attestation of each SD-WAN, which improves the ability of the FaaS Temporal SD-WAN 300 to provide improved data security throughout the entire sequence of functions. Each SD-WAN may be defined based on a security level, such as based on various classes (e.g., types) of workloads. For example, various classes of FaaS workloads may each be associated with requirements or preferred operational levels for security, safety, reliability, or resiliency, and the FaaS Temporal SD-WAN 300 may implement each SD-WAN based on those requirements or preferred operational levels. The FaaS Temporal SD-WAN 300 may use this security level to determine a corresponding level of attestation (e.g., relevant physical attributes of the hosting environments), and each SD-WAN may be selected or configured to provide the corresponding level of attestation.

The attestation levels may be further defined or configured based on various requests or requirements for the computing request, such as requests or requirements outlined in a service level agreement (SLA) or Quality of Service (QoS) requirements associated with the computing request. To provide the appropriate attestation, the FaaS Temporal SD-WAN 300 may track service performance for each SD-WAN, and may modify resource allocation based on the tracked service performance. In an example, the FaaS Temporal SD-WAN 300 may detect a reduced performance of an SD-WAN, and may increase a switch bandwidth or switch priority in response to the detected reduction in performance.

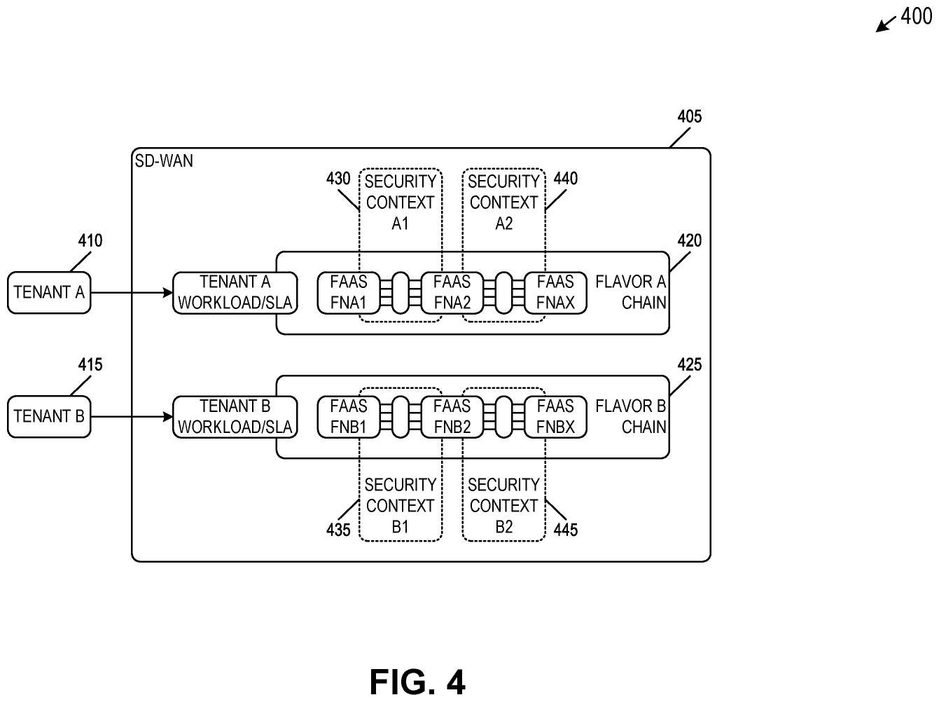

FIG. 4 is a block diagram illustrating a multiple tenant SD-WAN workflow 400, according to an embodiment. The multiple tenant SD-WAN workflow 400 may include a multiple tenant SD-WAN 405, which may be used to service computing requests for multiple tenants. In an example, a first computing request from tenant A 410 may be implemented within flavor A chain 420, and a separate computing request from tenant B 415 may be implemented within flavor B chain 425. Each flavor chain may have multiple containerized functions (e.g., multiple FaaS), and the connections between each pair of functions (e.g., the input and output data between the pair of functions) may be protected by a security context. In an example, flavor A chain 420 includes security context A1 430 between the first and second containerized function, and includes security context A2 440 between the second and third functions. Similarly, flavor B chain 425 includes security context B1 435 between its first and second functions, and includes security context B2 445 between its second and third functions.

In various examples, each security context may contain data encryption keys, symmetric or asymmetric identity keys, attestation keys, and attestation policies for verifying a next node in the FaaS chain. The keys used in each security context may be derived using an attestable root of trust, such as a Device Identity Composition Engine (DICE), a DICE Protection Environment (DPE), Caliptra Open-Source Root of Trust, a Trusted Platform Module (TPM), or other attestable root of trust technology.

To provide improved performance during execution of each flavor chain, the security contexts for each flavor chain may be precomputed. The precomputation of each security context may reduce latency or reduce computation resources used in generating each SD-WAN, and may reduce execution jitter (e.g., fluctuation in delay in executing each FaaS) during execution of the flavor chain. This improves the ability to dynamically generate an attested security context for each FaaS Flavor used by a given SD-WAN.

The multiple tenant SD-WAN 405 may provide rapid initialization or destruction (e.g., dismantling) of one or more flavor chains. In an example, when multiple tenant SD-WAN 405 is dismantled, this may result in dismantling of both flavor A chain 420 and flavor B chain 425. In another example, multiple tenant SD-WAN 405 may be configured such that either flavor A chain 420 or flavor B chain 425 may be dismantled without dismantling the other flavor chain.

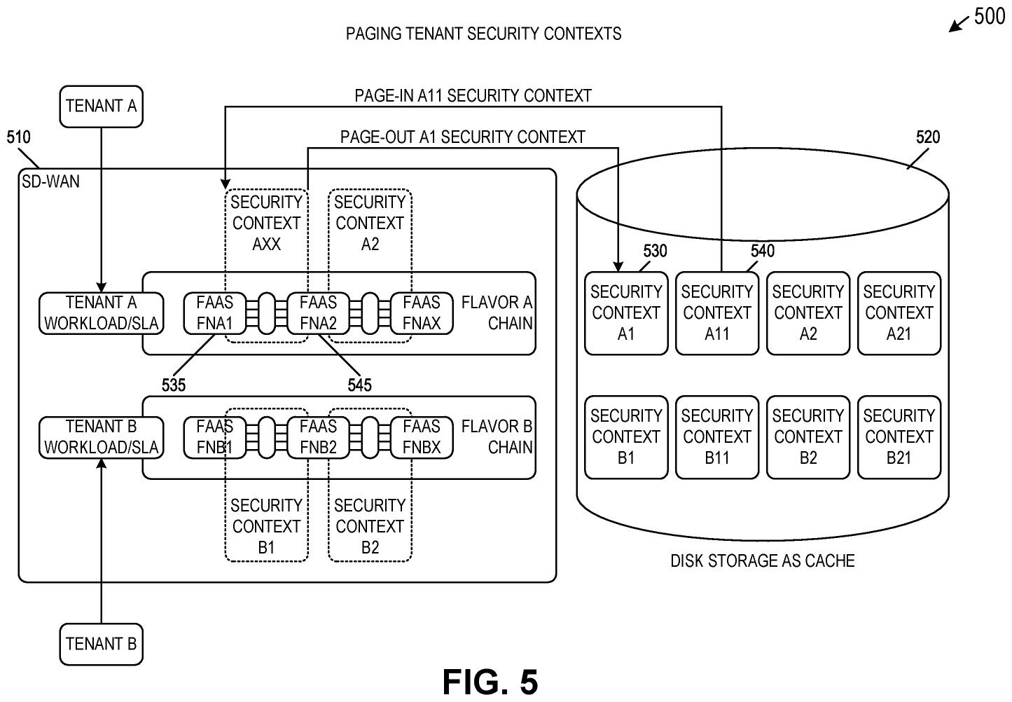

The dismantling of any flavor chain may typically result in the dismantling of associated security contexts. However, in cases where a tenant is a frequent subscriber of workloads involving the same FaaS functions or flavors, the dismantling operations may not be complete. A tenant-specific security context may be encrypted (e.g., wrapped) by a storage key (e.g., tenant-specific storage key, SLA-specific storage key, etc.). The storage key may be discarded by the hosting environment at the conclusion of the execution, and the storage key may be reasserted by the tenant the next time the tenant requests the FaaS flavor chain. In an example, the multiple tenant SD-WAN 405 may release memory associated with security context A1 430 and security context A2 440 after completion of the flavor A chain 420, and tenant A 410 may subsequently request execution of flavor A chain 420 and reassert both security context A1 430 and security context A2 440. The security key may be reasserted after dismantling of a flavor chain, or may be reasserted after expiration of a predetermined amount of time between subsequent executions of a flavor chain. When reasserting a security key, the multiple tenant SD-WAN 405 may retrieve a storage key from a secure memory paging architecture, such as the paging tenant security contexts shown in FIG. 5.

FIG. 5 is a block diagram illustrating paging tenant security contexts 500, according to an embodiment. The tenant security contexts 500 provide a security context exchange between SD-WAN 510 and disk storage as cache 520. The tenant security contexts 500 may be used to provide paging (e.g., retrieval of preconfigured data or processes) of tenant security contexts from disk storage as cache 520 into one or more FaaS flavor chains within SD-WAN 510. The SD-WAN 510 and disk storage as cache 520 may be used for constructing and on-demand paging of a tenant-specific FaaS flavor chains security contexts. Following execution of a FaaS flavor chain, the security context paging may include encrypting a security context by a storage key, discarding the storage key, and paging out the encrypted security context to disk storage as cache 520. In an example shown in FIG. 5, security context A11 540 is paged-out to disk storage as cache 520 following completion of FaaS function A2 545. When a FaaS flavor chain is subsequently asserted, the security context paging may include paging in the encrypted security context from disk storage as cache 520, reasserting the storage key, and decrypting the security context by the storage key. In the example shown in FIG. 5, during a subsequent assertion of the FaaS flavor A chain, security context A11 540 is paged-in to FaaS FNA1 535.

The disk storage as cache 520 may be implemented in a centralized storage scheme (e.g., a single logical or physical memory device) or in a distributed storage scheme (e.g., across multiple logical or physical memory devices). The disk storage as cache 520 may include non-volatile memory, such as Intel Optane memory, 3D XPoint non-volatile memory (NVM) memory, NOT-AND (NAND) flash memory, solid-state drive (SSD) memory, self-encrypting drive (SED) memory, hard disk drive (HDD) memory, magnetic disk memory, magnetic tape memory, and other types of non-volatile memory. The disk storage as cache 520 may be partitioned into security zones to create virtual barriers for security isolation between tenants, flavors, or security contexts, such as using Trusted Computing Group (TCG) Opal Storage Specification for SED memory, an IEEE1663 security overlay, or other SSD or SED virtual barriers.

In an example, the security context A11 540 may match the previously used image of security context A1 530. In another example, security context A11 540 may be updated subsequent to paging such that it differs from the previously used image of security context A1 530. Security context updates may be applied as a part of key management activities for various security purposes, such as to provision or reprovision security key, security tickets, security tokens, security certificates, or other security credentials. A software or firmware update may trigger a change to attestation keys when the attestation keys are derived from DICE layering, such as when a firmware initializes (e.g., seeds) a repeatable key generation function. A configuration change may also function as a key management event that may result in updated attestation keys, updated attestation evidence, or updated security contexts, such as to reflect the security level adjustments due to configuration changes. Tenant or FaaS flavor policies may be used to determine parameters of acceptable configurations, which may trigger an update to a tenant security context in response to a firmware update or other configuration changes.

The security context updates may be applied by a Flavor Management Service (FMS) or similar security administration entity. The FMS may use a storage partitioning scheme that employs storage grade encryption, such as to protect security credentials from physical attackers who may recover the paging or caching device and subject it to a variety of brute force attacks. The FMS may manage SED keys and partitions according to isolation requirements defined by the tenant or defined by an associated SLA.

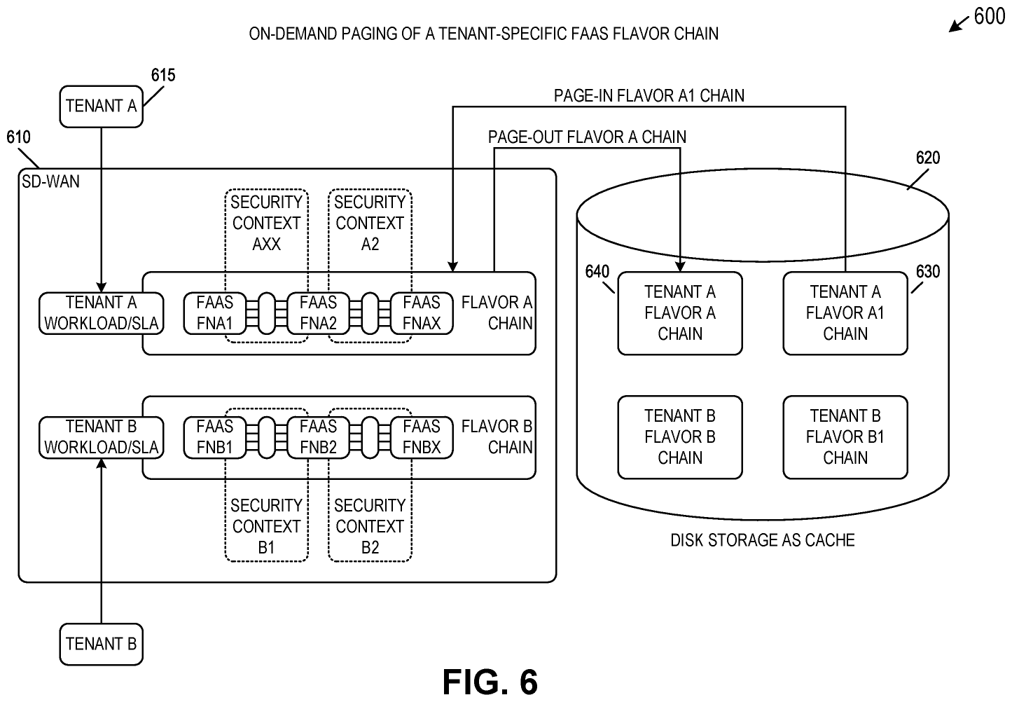

FIG. 6 is a block diagram illustrating tenant-specific FaaS flavor chain on-demand paging 600, according to an embodiment. Compared to the tenant security context 500 providing a security context exchange, the tenant-specific FaaS flavor chain on-demand paging 600 provides a tenant-specific FaaS flavor exchange between SD-WAN 610 and disk storage as cache 620. The FaaS flavor chain on-demand paging 600 may be used to provide paging of a FaaS flavor chain that is specific to tenant A 615. Each FaaS flavor chain that is paged-in or paged-out may include functions, data, and security contexts needed to execute that FaaS flavor chain. In an example, a FaaS request from tenant A 615 may determine which FaaS flavor chain to page-in, such as identifying tenant A flavor A chain 640. In another example, a flavor chain is paged-out following execution of a flavor chain, and is subsequently paged-in upon the next request for execution of that flavor chain. In an example shown in FIG. 6, tenant A flavor A1 chain 630 is paged-out from SD-WAN 610 to disk storage as cache 620 following execution of FaaS flavor A chain, and upon the next request for execution of flavor A chain, tenant A flavor A chain 640 is paged-in from disk storage as cache 620 to SD-WAN 610.

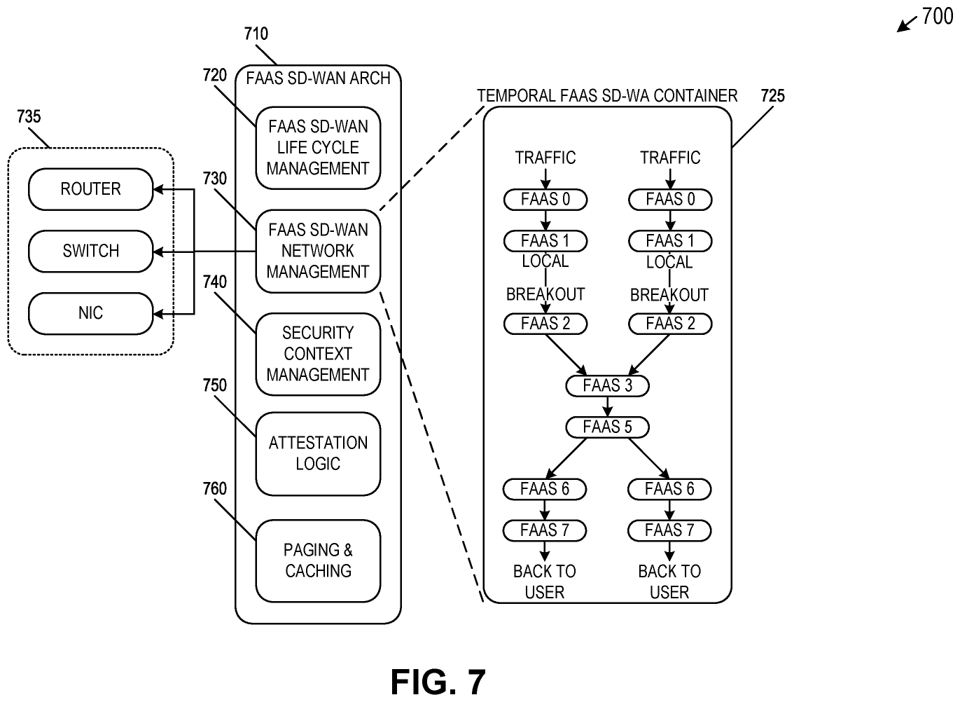

FIG. 7 is a block diagram illustrating FaaS SD-WAN components 700, according to an embodiment. The FaaS SD-WAN components 700 include a FaaS SD-WAN architecture 710, which includes various components that may be used to implement or secure a temporal FaaS SD-WAN. Each of the components within FaaS SD-WAN architecture 710 may be implemented as a logical programming module (e.g., application programming interface (API)), as a physical special-purpose circuit (e.g., on an application-specific integrated circuit (ASIC), on a System-On-a-Chip (SOC)), or in a combination of physical and logical components.

The FaaS SD-WAN architecture 710 may include a FaaS SD-WAN Life Cycle Management component 720. The FaaS SD-WAN Life Cycle Management component 720 may provide interfaces to various services, such as to create an instance of a particular service with particular service requirements (e.g., security, data retention). The FaaS SD-WAN Life Cycle Management component 720 may interact with other components within FaaS SD-WAN architecture 710 to identify the edge nodes where the functions are to be established, create the temporal FaaS SD-WAN container 725, track the performance of the temporal FaaS SD-WAN container 725 (e.g., monitoring network Quality of Service (QoS), and destroy the temporal FaaS SD-WAN container 725 after the service has been completed.

The FaaS SD-WAN architecture 710 may include a FaaS SD-WAN network management component 730. The FaaS SD-WAN network management component 730 may be used to create the temporal FaaS SD-WAN container 725 based on a computing service request. A computing service request may include requests or requirements for various FaaS flavor instances, and the FaaS SD-WAN network management component 730 may configure one or more edge computing networking components 735 (e.g., router, switch, NIC). In various examples, the configuration of the computing networking components 735 may include configuring the requested or required security levels, QoS levels, computing performance levels, data isolation, or other requests or requirements for that FaaS flavor instance.

The FaaS SD-WAN architecture 710 may include a security context management component 740. The security context management component 740 may be used to manage security contexts for each FaaS flavor chain. This security context management may include paging-in and paging-out security contexts from disk storage as cache, where security contexts may be specific to a tenant or specific to a FaaS flavor chain. The security context management component 740 may apply security context updates as a part of key management activities for various security purposes, such as to provision or reprovision various security credentials.

The FaaS SD-WAN architecture 710 may include an attestation logic component 750. The attestation logic component 750 may provide attestation interfaces to for requested computing services, which may be used to validate and attest content provided by other services. The attestation logic component 750 may interact with the security context management component 740 to provide these attestation interfaces.

The FaaS SD-WAN architecture 710 may include a paging and caching logic component 760. The paging and caching logic component 760 may provide the paging-in and paging-out of security contexts or FaaS flavors from disk storage as cache. The paging and caching logic component 760 may manage disk storage as cache implemented either in a centralized storage scheme or in a distributed storage scheme.

The components within FaaS SD-WAN architecture 710 may be implemented in various combinations of computer components or instructions. In various examples, the FaaS SD-WAN architecture 710 components may be implemented in an integrated circuit (e.g., hardcoded circuitry), within firmware, within specialized hardware circuitry (e.g., field-programmable gate array (FPGA)), application specific integrated circuit (ASIC), a system-on-a-chip (SOC)), or within a similar electronic component.

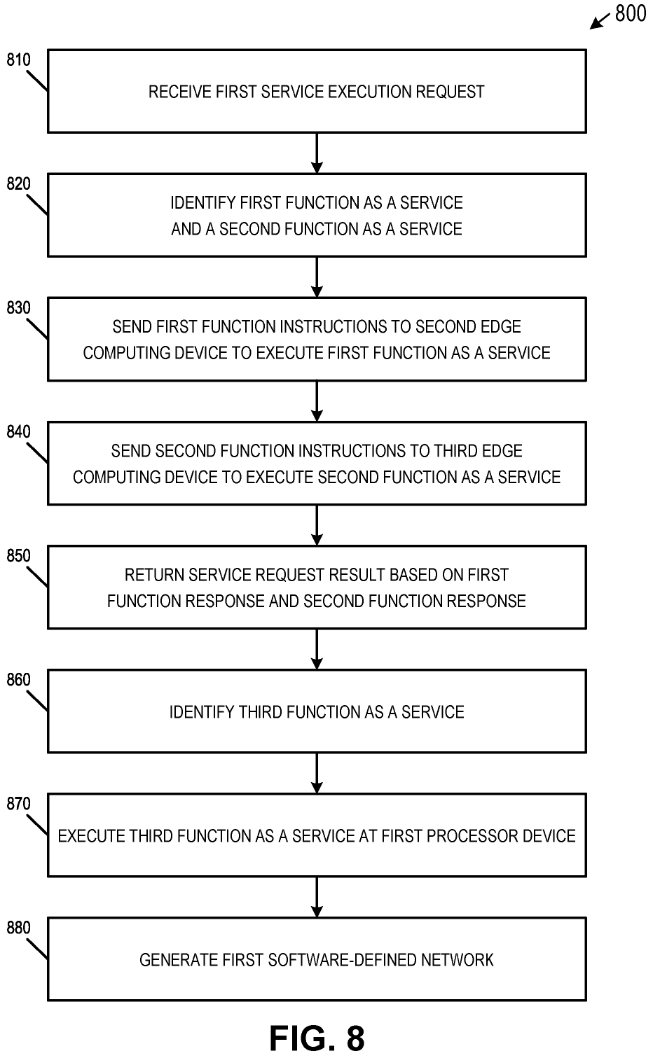

FIG. 8 is a flow diagram illustrating a method 800 for secure and attestable functions-as-a-service. Method 800 includes receiving 810 a first service execution request at a first edge computing device, the first edge computing device including a first processor device and a first memory. Method 800 further includes identifying 820, based on the first service execution request, a first function as a service and a second function as a service. Method 800 further includes sending 830 first function instructions to a second processor device on a second edge computing device to execute the first function as a service and return a first function response. Method further 800 may further include sending 840 second function instructions to a third processor device on a third edge computing device to execute the second function as a service and provide a second function response. Method further 800 may further include returning 850 a service request result of the first service execution request based on the first function response and the second function response.

Method 800 may further include identifying 860, based on the first service execution request, a third function as a service. Method 800 may further include executing 870 the third function as a service at the first processor device at the first edge computing device and return a third function response. The service request result may be further based on the third function response. Method 800 may further include generating 880 a first software-defined network at the first processor device based on the first service execution request. The first function as a service may be executed at the first software-defined network.

The first or second processor device may be attested as part of a binding of an execution resource as part of a SW defined network. The function to be executed may be assessed according to a security context, where the assessment determines whether the protection properties of the first or second processor device are sufficient to protect the workload to be executed. The execution of the first function as a service at the first processor device or the execution of the second function as a service at the second processor device may be in response to a security context assessment result.

In response to the first service execution request, a function as a service flavor chain may be paged in from a first disk cache as storage. The first software-defined network and the second software-defined network may be generated based on the service flavor chain.

In response to a first completion of the first function as a service, the first software-defined network may be destroyed. In response to a second completion of the second function as a service, the second software-defined network may be destroyed.

Subsequent to a completion of the first service execution request, a second computing request may be received. The second computing request may include a request to execute the first function as a service and the second function as a service. A security attestation period may be determined to have elapsed since the completion of the first service execution request. In response to the determination, a first security of the first software-defined network and a second security of the second software-defined network may be attested. In response to attesting the first security of the first software-defined network, the first function may be executed as a service. Similarly, in response to attesting the second security of the second software-defined network, instructions may be sent to the second processor device to execute the second function as a service.

A third function as a service may be identified based on the first service execution request. In response to the identification, instructions may be sent to a third processor device on the first edge computing device to execute the third function as a service.

The first function as a service may generate a first intermediate result executed at the first edge computing device. The second function as a service may generate a second intermediate result based on the first intermediate result. The service request result may be generated based on the second intermediate result.

A first security context may be paged-in at the first processor device. A first secure network connection may be generated between the first edge computing device and the second edge computing device. The first intermediate result may be sent via the first secure network connection. In an example, a security attestation for the first intermediate result may be sent with the first intermediate result via the first secure network connection.

A first security context may be paged-out from the second edge computing device subsequent to sending the first intermediate result via the first secure network connection. The first security context may be paged-out from the second edge computing device to the second disk cache as storage. During a subsequent execution of the function as a service, a second security context may be paged-in from a second disk cache as storage device to the first edge computing device. A security attestation result from a first edge computing device may be compared with a stored attestation result (e.g., expected attestation result). The comparison may include determining that a change in attestation status occurred during execution and whether the paged in security context contains the appropriate protections before continuing with the second stage of the FaaS chain processing.

The first edge computing device may be in networked communication with a second edge computing device. The first edge computing device may be in a first location and the second edge computing device may be in a second location, where the second location is different from the first location. The first processor device may include at least one of a logical processor device and a physical processor device.

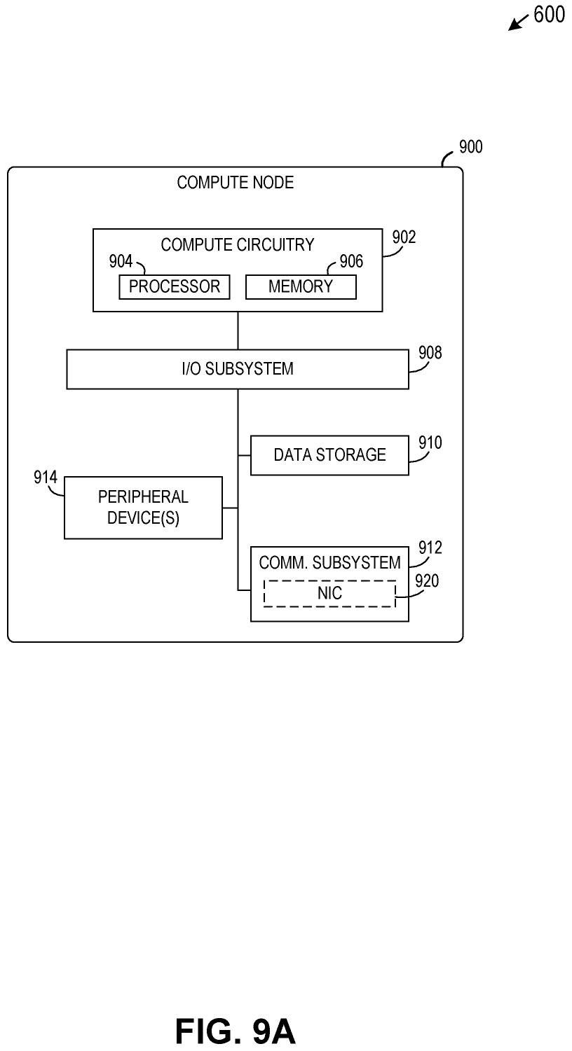

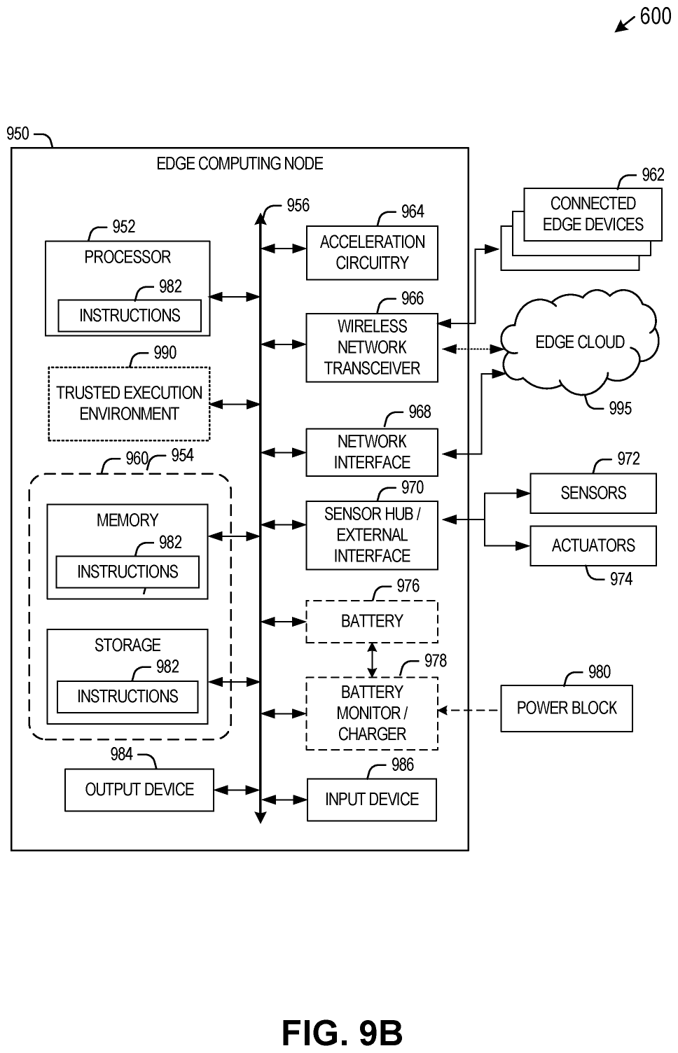

FIGS. 9A and 9B provide an overview of example components within a computing device in an edge computing system 900, according to an embodiment. Edge computing system 900 may be used to provide secure and attestable functions-as-a-service, such as using method 800 and related systems and methods described above with respect to FIGS. 1-8.

In further examples, any of the compute nodes or devices discussed with reference to the present edge computing systems and environment may be fulfilled based on the components depicted in FIGS. 9A and 9B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 9A, an edge compute node 900 includes a compute engine (also referred to herein as “compute circuitry”) 902, an input/output (I/O) subsystem 908 (also referred to herein as “I/O circuitry”), data storage 910 (also referred to herein as “data storage circuitry”), a communication circuitry subsystem 912, and, optionally, one or more peripheral devices 914 (also referred to herein as “peripheral device circuitry”). In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 900 may be embodied as any type of engine, device, or collection of devices capable of performing various compute functions. In some examples, the compute node 900 may be embodied as a single device such as an integrated circuit, an embedded system, a field-programmable gate array (FPGA), a system-on-a-chip (SOC), or other integrated system or device. In the illustrative example, the compute node 900 includes or is embodied as a processor 904 (also referred to herein as “processor circuitry”) and a memory 906 (also referred to herein as “memory circuitry”). The processor 904 may be embodied as any type of processor capable of performing the functions described herein (e.g., executing an application). For example, the processor 904 may be embodied as a multi-core processor(s), a microcontroller, a processing unit, a specialized or special purpose processing unit, or other processor or processing/controlling circuit.

In some examples, the processor 904 may be embodied as, include, or be coupled to an FPGA, an application specific integrated circuit (ASIC), reconfigurable hardware or hardware circuitry, or other specialized hardware to facilitate performance of the functions described herein. In some examples, the processor 904 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, storage disks, or AI hardware (e.g., GPUs, programmed FPGAs, or ASICs tailored to implement an AI model such as a neural network). Such an xPU may be designed to receive, retrieve, and/or otherwise obtain programming to process one or more data streams and perform specific tasks and actions for the data streams (such as hosting microservices, performing service management or orchestration, organizing or managing server or data center hardware, managing service meshes, or collecting and distributing telemetry), outside of the CPU or general-purpose processing hardware. However, it will be understood that a xPU, a SOC, a CPU, and other variations of the processor 904 may work in coordination with each other to execute many types of operations and instructions within and on behalf of the compute node 900.

The memory 906 may be embodied as any type of volatile (e.g., dynamic random-access memory (DRAM), etc.) or non-volatile memory or data storage capable of performing the functions described herein. Volatile memory may be a storage medium that requires power to maintain the state of data stored by the medium. Non-limiting examples of volatile memory may include various types of random-access memory (RAM), such as DRAM or static random-access memory (SRAM). One particular type of DRAM that may be used in a memory module is synchronous dynamic random-access memory (SDRAM).

In an example, the memory device (e.g., memory circuitry) is any number of block addressable memory devices, such as those based on NAND or NOR technologies (for example, Single-Level Cell (“SLC”), Multi-Level Cell (“MLC”), Quad-Level Cell (“QLC”), Tri-Level Cell (“TLC”), or some other NAND). In some examples, the memory device(s) includes a byte-addressable write-in-place three dimensional crosspoint memory device, or other byte addressable write-in-place non-volatile memory (NVM) devices, such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric transistor random access memory (FeTRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, a combination of any of the above, or other suitable memory. A memory device may also include a three-dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may include a transistor-less stackable cross point architecture in which memory cells sit at the intersection of word lines and bit lines and are individually addressable and in which bit storage is based on a change in bulk resistance. In some examples, all or a portion of the memory 906 may be integrated into the processor 904. The memory 906 may store various software and data used during operation such as one or more applications, data operated on by the application(s), libraries, and drivers.

In some examples, resistor-based and/or transistor-less memory architectures include nanometer scale phase-change memory (PCM) devices in which a volume of phase-change material resides between at least two electrodes. Portions of the example phase-change material exhibit varying degrees of crystalline phases and amorphous phases, in which varying degrees of resistance between the at least two electrodes can be measured. In some examples, the phase-change material is a chalcogenide-based glass material. Such resistive memory devices are sometimes referred to as memristive devices that remember the history of the current that previously flowed through them. Stored data is retrieved from example PCM devices by measuring the electrical resistance, in which the crystalline phases exhibit a relatively lower resistance value(s) (e.g., logical “0”) when compared to the amorphous phases having a relatively higher resistance value(s) (e.g., logical “1”).

Example PCM devices store data for long periods of time (e.g., approximately 10 years at room temperature). Write operations to example PCM devices (e.g., set to logical “0,” set to logical “1,” set to an intermediary resistance value) are accomplished by applying one or more current pulses to the at least two electrodes, in which the pulses have a particular current magnitude and duration. For instance, a long low current pulse (SET) applied to the at least two electrodes may cause the example PCM device to reside in a low-resistance crystalline state, while a comparatively short high current pulse (RESET) applied to the at least two electrodes causes the example PCM device to reside in a high-resistance amorphous state.

In some examples, implementation of PCM devices facilitates non-von Neumann computing architectures that enable in-memory computing capabilities. Generally speaking, traditional computing architectures include a central processing unit (CPU) communicatively connected to one or more memory devices via a bus. As such, a finite amount of energy and time is consumed to transfer data between the CPU and memory, which is a known bottleneck of von Neumann computing architectures. However, PCM devices minimize and, in some cases, eliminate data transfers between the CPU and memory by performing some computing operations in-memory. Stated differently, PCM devices both store information and execute computational tasks. Such non-von Neumann computing architectures may implement vectors having a relatively high dimensionality to facilitate hyperdimensional computing, such as vectors having 10,000 bits. Relatively large bit width vectors enable computing paradigms modeled after the human brain, which also processes information analogous to wide bit vectors.

The compute circuitry 902 is communicatively coupled to other components of the compute node 900 via the I/O subsystem 908, which may be embodied as circuitry and/or components to facilitate input/output operations with the compute circuitry 902 (e.g., with the processor 904 and/or the main memory 906) and other components of the compute circuitry 902. For example, the I/O subsystem 908 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 908 may form a portion of a system-on-a-chip (SoC) and be incorporated, along with one or more of the processor 904, the memory 906, and other components of the compute circuitry 902, into the compute circuitry 902.

The one or more illustrative data storage devices/disks 910 may be embodied as one or more of any type(s) of physical device(s) configured for short-term or long-term storage of data such as, for example, memory devices, memory, circuitry, memory cards, flash memory, hard disk drives, solid-state drives (SSDs), and/or other data storage devices/disks. Individual data storage devices/disks 910 may include a system partition that stores data and firmware code for the data storage device/disk 910. Individual data storage devices/disks 910 may also include one or more operating system partitions that store data files and executables for operating systems depending on, for example, the type of compute node 900.

The communication circuitry 912 may be embodied as any communication circuit, device, or collection thereof, capable of enabling communications over a network between the compute circuitry 902 and another compute device (e.g., an edge gateway of an implementing edge computing system). The communication circuitry 912 may be configured to use any one or more communication technology (e.g., wired or wireless communications) and associated protocols (e.g., a cellular networking protocol such a 3GPP 4G or 5G standard, a wireless local area network protocol such as IEEE 1102.11/Wi-Fi®, a wireless wide area network protocol, Ethernet, Bluetooth®, Bluetooth Low Energy, a IoT protocol such as IEEE 1102.15.4 or ZigBee®, low-power wide-area network (LPWAN) or low-power wide-area (LPWA) protocols, etc.) to effect such communication.

The illustrative communication circuitry 912 includes a network interface controller (NIC) 920, which may also be referred to as a host fabric interface (HFI). The NIC 920 may be embodied as one or more add-in-boards, daughter cards, network interface cards, controller chips, chipsets, or other devices that may be used by the compute node 900 to connect with another compute device (e.g., an edge gateway node). In some examples, the NIC 920 may be embodied as part of a system-on-a-chip (SoC) that includes one or more processors, or included on a multichip package that also contains one or more processors. In some examples, the NIC 920 may include a local processor (not shown) and/or a local memory (not shown) that are both local to the NIC 920. In such examples, the local processor of the NIC 920 may be capable of performing one or more of the functions of the compute circuitry 902 described herein. Additionally, or alternatively, in such examples, the local memory of the NIC 920 may be integrated into one or more components of the client compute node at the board level, socket level, chip level, and/or other levels.

Additionally, in some examples, a respective compute node 900 may include one or more peripheral devices 914. Such peripheral devices 914 may include any type of peripheral device found in a compute device or server such as audio input devices, a display, other input/output devices, interface devices, and/or other peripheral devices, depending on the particular type of the compute node 900. In further examples, the compute node 900 may be embodied by a respective edge compute node (whether a client, gateway, or aggregation node) in an edge computing system or like forms of appliances, computers, subsystems, circuitry, or other components.

In a more detailed example, FIG. 9B illustrates a block diagram of an example of components that may be present in an edge computing node 950 for implementing the techniques (e.g., operations, processes, methods, and methodologies) described herein. This edge computing node 950 provides a closer view of the respective components of node 900 when implemented as or as part of a computing device (e.g., as a mobile device, a base station, server, gateway, etc.). The edge computing node 950 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 950, or as components otherwise incorporated within a chassis of a larger system.

The edge computing device 950 may include processing circuitry in the form of a processor 952, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 952 may be a part of a system on a chip (SoC) in which the processor 952 and other components are formed into a single integrated circuit, or a single package, such as the Edison™ or Galileo™ SoC boards from Intel Corporation, Santa Clara, California. As an example, the processor 952 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, California, a MIPS®-based design from MIPS Technologies, Inc. of Sunnyvale, California, an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 952 and accompanying circuitry may be provided in a single socket form factor, multiple socket form factor, or a variety of other formats, including in limited hardware configurations or configurations that include fewer than all elements shown in FIG. 9B.

The processor 952 may communicate with a system memory 954 over an interconnect 956 (e.g., a bus). Any number of memory devices may be used to provide for a given amount of system memory. As examples, the memory 954 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 958 may also couple to the processor 952 via the interconnect 956. In an example, the storage 958 may be implemented via a solid-state disk drive (SSDD). Other devices that may be used for the storage 958 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 958 may be on-die memory or registers associated with the processor 952. However, in some examples, the storage 958 may be implemented using a micro hard disk drive (HDD). Further, any number of new technologies may be used for the storage 958 in addition to, or instead of, the technologies described, such resistance change memories, phase change memories, holographic memories, or chemical memories, among others.

The components may communicate over the interconnect 956. The interconnect 956 may include any number of technologies, including industry standard architecture (ISA), extended ISA (EISA), peripheral component interconnect (PCI), peripheral component interconnect extended (PCIx), PCI express (PCIe), or any number of other technologies. The interconnect 956 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 956 may couple the processor 952 to a transceiver 966, for communications with the connected edge devices 962. The transceiver 966 may use any number of frequencies and protocols, such as 2.4 Gigahertz (GHz) transmissions under the IEEE 1102.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 962. For example, a wireless local area network (WLAN) unit may be used to implement Wi-Fi® communications in accordance with the Institute of Electrical and Electronics Engineers (IEEE) 1102.11 standard. In addition, wireless wide area communications, e.g., according to a cellular or other wireless wide area protocol, may occur via a wireless wide area network (WWAN) unit.

The wireless network transceiver 966 (or multiple transceivers) may communicate using multiple standards or radios for communications at a different range. For example, the edge computing node 950 may communicate with close devices, e.g., within about 10 meters, using a local transceiver based on Bluetooth Low Energy (BLE), or another low power radio, to save power. More distant connected edge devices 962, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 966 (e.g., a radio transceiver) may be included to communicate with devices or services in a cloud (e.g., an edge cloud 995) via local or wide area network protocols. The wireless network transceiver 966 may be a low-power wide-area (LPWA) transceiver that follows the IEEE 1102.15.4, or IEEE 1102.15.4g standards, among others. The edge computing node 950 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 1102.15.4e specification may be used.

Any number of other radio communications and protocols may be used in addition to the systems mentioned for the wireless network transceiver 966, as described herein. For example, the transceiver 966 may include a cellular transceiver that uses spread spectrum (SPA/SAS) communications for implementing high-speed communications. Further, any number of other protocols may be used, such as Wi-Fi® networks for medium speed communications and provision of network communications. The transceiver 966 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 968 may be included to provide a wired communication to nodes of the edge cloud 995 or to other devices, such as the connected edge devices 962 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 968 may be included to enable connecting to a second network, for example, a first NIC 968 providing communications to the cloud over Ethernet, and a second NIC 968 providing communications to other devices over another type of network.

Given the variety of types of applicable communications from the device to another component or network, applicable communications circuitry used by the device may include or be embodied by any one or more of components 964, 966, 968, or 970. Accordingly, in various examples, applicable means for communicating (e.g., receiving, transmitting, etc.) may be embodied by such communications circuitry.

The edge computing node 950 may include or be coupled to acceleration circuitry 964, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 956 may couple the processor 952 to a sensor hub or external interface 970 that is used to connect additional devices or subsystems. The devices may include sensors 972, such as accelerometers, level sensors, flow sensors, optical light sensors, camera sensors, temperature sensors, global navigation system (e.g., GPS) sensors, pressure sensors, barometric pressure sensors, and the like. The hub or interface 970 further may be used to connect the edge computing node 950 to actuators 974, such as power switches, valve actuators, an audible sound generator, a visual warning device, and the like.

In some optional examples, various input/output (I/O) devices may be present within or connected to, the edge computing node 950. For example, a display or other output device 984 may be included to show information, such as sensor readings or actuator position. An input device 986, such as a touch screen or keypad may be included to accept input. An output device 984 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 950. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 976 may power the edge computing node 950, although, in examples in which the edge computing node 950 is mounted in a fixed location, it may have a power supply coupled to an electrical grid, or the battery may be used as a backup or for temporary capabilities. The battery 976 may be a lithium ion battery, or a metal-air battery, such as a zinc-air battery, an aluminum-air battery, a lithium-air battery, and the like.

A battery monitor/charger 978 may be included in the edge computing node 950 to track the state of charge (SoCh) of the battery 976, if included. The battery monitor/charger 978 may be used to monitor other parameters of the battery 976 to provide failure predictions, such as the state of health (SoH) and the state of function (SoF) of the battery 976. The battery monitor/charger 978 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 978 may communicate the information on the battery 976 to the processor 952 over the interconnect 956. The battery monitor/charger 978 may also include an analog-to-digital (ADC) converter that enables the processor 952 to directly monitor the voltage of the battery 976 or the current flow from the battery 976. The battery parameters may be used to determine actions that the edge computing node 950 may perform, such as transmission frequency, mesh network operation, sensing frequency, and the like.

A power block 980, or other power supply coupled to a grid, may be coupled with the battery monitor/charger 978 to charge the battery 976. In some examples, the power block 980 may be replaced with a wireless power receiver to obtain the power wirelessly, for example, through a loop antenna in the edge computing node 950. A wireless battery charging circuit, such as an LTC4020 chip from Linear Technologies of Milpitas, California, among others, may be included in the battery monitor/charger 978. The specific charging circuits may be selected based on the size of the battery 976, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 958 may include instructions 982 in the form of software, firmware, or hardware commands to implement the techniques described herein. Although such instructions 982 are shown as code blocks included in the memory 954 and the storage 958, it may be understood that any of the code blocks may be replaced with hardwired circuits, for example, built into an application specific integrated circuit (ASIC).

In an example, the instructions 982 provided via the memory 954, the storage 958, or the processor 952 may be embodied as a non-transitory, machine-readable medium 960 including code to direct the processor 952 to perform electronic operations in the edge computing node 950. The processor 952 may access the non-transitory, machine-readable medium 960 over the interconnect 956. For instance, the non-transitory, machine-readable medium 960 may be embodied by devices described for the storage 958 or may include specific storage units such as storage devices and/or storage disks that include optical disks (e.g., digital versatile disk (DVD), compact disk (CD), CD-ROM, Blu-ray disk), flash drives, floppy disks, hard drives (e.g., SSDs), or any number of other hardware devices in which information is stored for any duration (e.g., for extended time periods, permanently, for brief instances, for temporarily buffering, and/or caching). The non-transitory, machine-readable medium 960 may include instructions to direct the processor 952 to perform a specific sequence or flow of actions, for example, as described with respect to the flowchart(s) and block diagram(s) of operations and functionality depicted above. As used herein, the terms “machine-readable medium” and “computer-readable medium” are interchangeable. As used herein, the term “non-transitory computer-readable medium” is expressly defined to include any type of computer readable storage device and/or storage disk and to exclude propagating signals and to exclude transmission media.

Also in a specific example, the instructions 982 on the processor 952 (separately, or in combination with the instructions 982 of the machine readable medium 960) may configure execution or operation of a trusted execution environment (TEE) 990. In an example, the TEE 990 operates as a protected area accessible to the processor 952 for secure execution of instructions and secure access to data. Various implementations of the TEE 990, and an accompanying secure area in the processor 952 or the memory 954 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 950 through the TEE 990 and the processor 952.

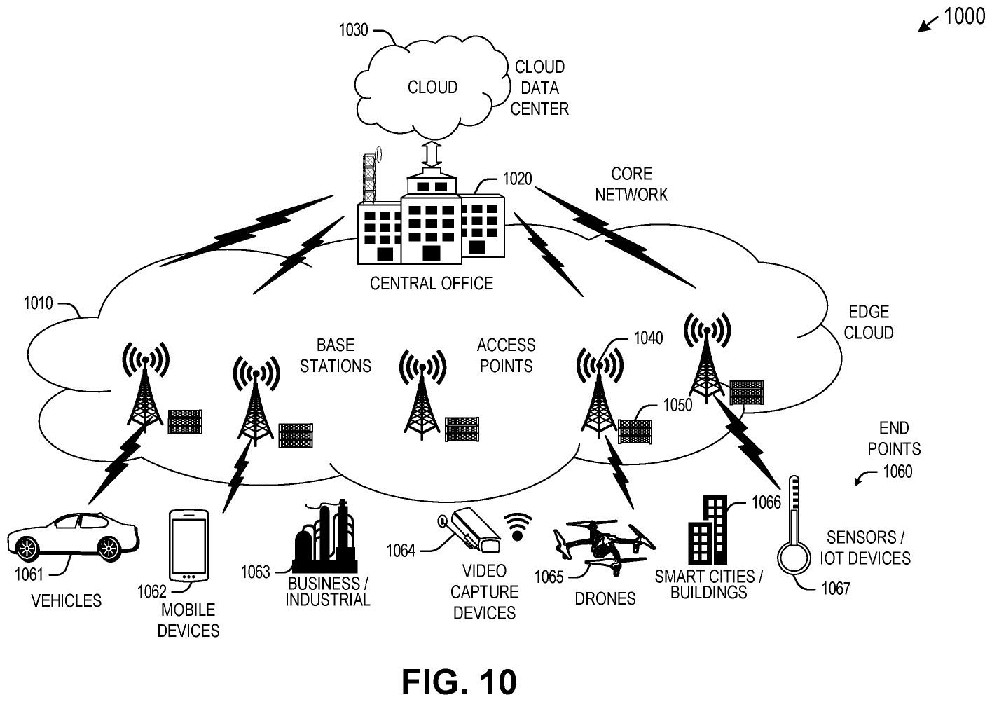

FIG. 10 is a block diagram showing an overview of a configuration for edge computing, which includes a layer of processing referred to in many of the following examples as an “edge cloud.” As shown, the edge cloud 1010 is co-located at an edge location, such as an access point or base station 1040, a local processing hub 1050, or a central office 1020, and thus may include multiple entities, devices, and equipment instances. The edge cloud 1010 is located much closer to the endpoint (consumer and producer) data sources 1060 (e.g., autonomous vehicles 1061, user equipment 1062, business and industrial equipment 1063, video capture devices 1064, drones 1065, smart cities and building devices 1066, sensors and IoT devices 1067, etc.) than the cloud data center 1030. Compute, memory, and storage resources which are offered at the edges in the edge cloud 1010 are critical to providing ultra-low latency response times for services and functions used by the endpoint data sources 1060 as well as reduce network backhaul traffic from the edge cloud 1010 toward cloud data center 1030 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce an amount or number of resources needed for network services, through the distribution of more resources which are located closer both geographically and in network access time. In this manner, edge computing attempts to bring the compute resources to the workload data where appropriate or bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge,” “close edge,” “local edge,” “middle edge,” or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

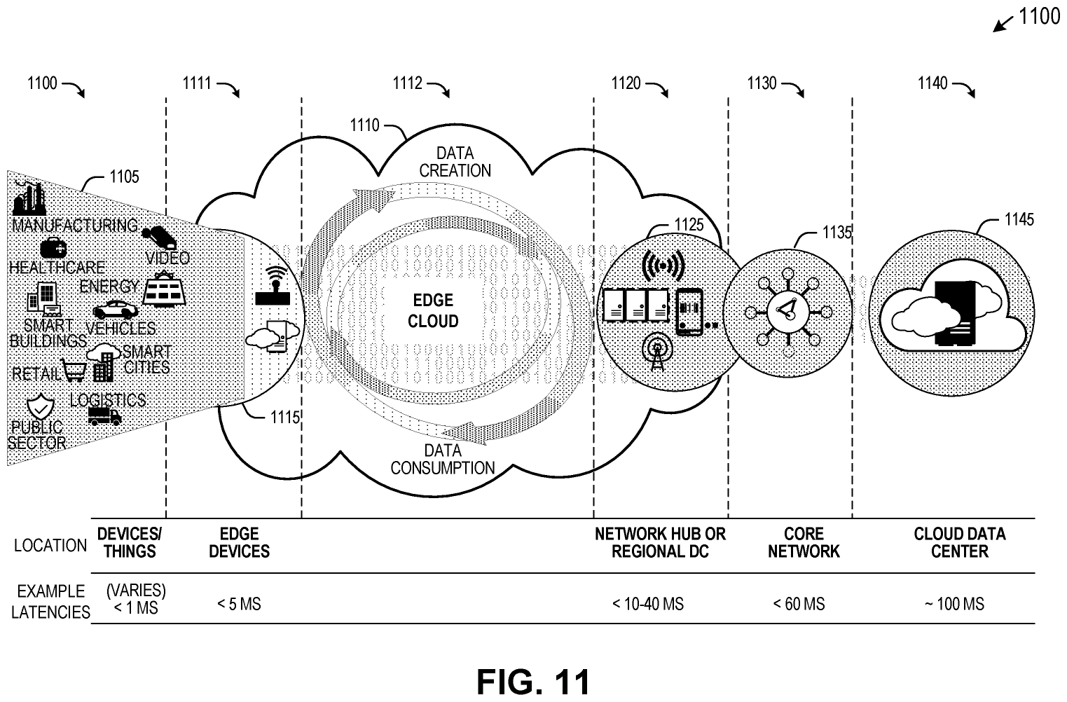

FIG. 11 illustrates operational layers among endpoints, an edge cloud, and cloud computing environments 1100, according to an embodiment. Specifically, FIG. 11 depicts examples of computational use cases 1105, using the edge cloud 1110 among multiple illustrative layers of network computing, such as using edge cloud 1010 shown in FIG. 10. The layers begin at an endpoint (devices and things) layer 1100, which accesses the edge cloud 1110 to conduct data creation, analysis, and data consumption activities. The edge cloud 1110 may span multiple network layers, such as an edge devices layer 1111 having gateways, on-premise servers, or network equipment (nodes 1115) located in physically proximate edge systems; a network access layer 1120, encompassing base stations, radio processing units, network hubs, regional data centers (DC), or local network equipment (equipment 1125); and any equipment, devices, or nodes located therebetween (in layer 1112, not illustrated in detail). The network communications within the edge cloud 1110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 1100, under 5 ms at the edge devices layer 1110, to even between 10 to 40 ms when communicating with nodes at the network access layer 1120. Beyond the edge cloud 1110 are core network 1130 and cloud data center 1140 layers, each with increasing latency (e.g., between 50-60 ms at the core network layer 1130, to 100 or more ms at the cloud data center layer). As a result, operations at a core network data center 1135 or a cloud data center 1145, with latencies of at least 50 to 100 ms or more, will not be able to accomplish many time-critical functions of the use cases 1105. Each of these latency values are provided for purposes of illustration and contrast; it will be understood that the use of other access network mediums and technologies may further reduce the latencies. In some examples, respective portions of the network may be categorized as “close edge,” “local edge,” “near edge,” “middle edge,” or “far edge” layers, relative to a network source and destination. For instance, from the perspective of the core network data center 1135 or a cloud data center 1145, a central office or content data network may be considered as being located within a “near edge” layer (“near” to the cloud, having high latency values when communicating with the devices and endpoints of the use cases 1105), whereas an access point, base station, on-premise server, or network gateway may be considered as located within a “far edge” layer (“far” from the cloud, having low latency values when communicating with the devices and endpoints of the use cases 1105). It will be understood that other categorizations of a particular network layer as constituting a “close,” “local,” “near,” “middle,” or “far” edge may be based on latency, distance, number of network hops, or other measurable characteristics, as measured from a source in any of the network layers 1100 through 1140.

The various use cases 1105 may access resources under usage pressure from incoming streams, due to multiple services utilizing the edge cloud. To achieve results with low latency, the services executed within the edge cloud 1110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to Service Level Agreement (SLA), the system as a whole (components in the transaction) may provide the ability to (1) understand the impact of the SLA violation, and (2) augment other components in the system to resume overall transaction SLA, and (3) implement remediation measures.

Thus, with these variations and service features in mind, edge computing within the edge cloud 1110 may provide the ability to serve and respond to multiple applications of the use cases 1105 (e.g., object tracking, video surveillance, connected cars, etc.) in real-time or near real-time, and meet ultra-low latency requirements for these multiple applications. These advantages enable a whole new class of applications (e.g., Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 1110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 1110 (network layers 1100 through 1140), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco,” or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 1110.

As such, the edge cloud 1110 is formed from network components and functional features operated by and within edge gateway nodes, edge aggregation nodes, or other edge compute nodes among network layers 1110 through 1130. The edge cloud 1110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 1110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

The network components of the edge cloud 1110 may be servers, multi-tenant servers, appliance computing devices, and/or any other type of computing devices. For example, the edge cloud 1110 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., electromagnetic interference (EMI), vibration, extreme temperatures, etc.), and/or enable submergibility. Example housings may include power circuitry to provide power for stationary and/or portable implementations, such as alternating current (AC) power inputs, direct current (DC) power inputs, AC/DC converter(s), DC/AC converter(s), DC/DC converter(s), power regulators, transformers, charging circuitry, batteries, wired inputs, and/or wireless power inputs. Example housings and/or surfaces thereof may include or connect to mounting hardware to enable attachment to structures such as buildings, telecommunication structures (e.g., poles, antenna structures, etc.), and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, infrared or other visual thermal sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, rotors such as propellers, etc.) and/or articulating hardware (e.g., robot arms, pivotable appendages, etc.). In some circumstances, the sensors may include any type of input devices such as user interface hardware (e.g., buttons, switches, dials, sliders, microphones, etc.). In some circumstances, example housings include output devices contained in, carried by, embedded therein and/or attached thereto. Output devices may include displays, touchscreens, lights, light-emitting diodes (LEDs), speakers, input/output (I/O) ports (e.g., universal serial bus (USB)), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 9B. The edge cloud 1110 may also include one or more servers and/or one or more multi-tenant servers. Such a server may include an operating system and implement a virtual computing environment. A virtual computing environment may include a hypervisor managing (e.g., spawning, deploying, commissioning, destroying, decommissioning, etc.) one or more virtual machines, one or more containers, etc. Such virtual computing environments provide an execution environment in which one or more applications and/or other software, code, or scripts may execute while being isolated from one or more other applications, software, code, or scripts.

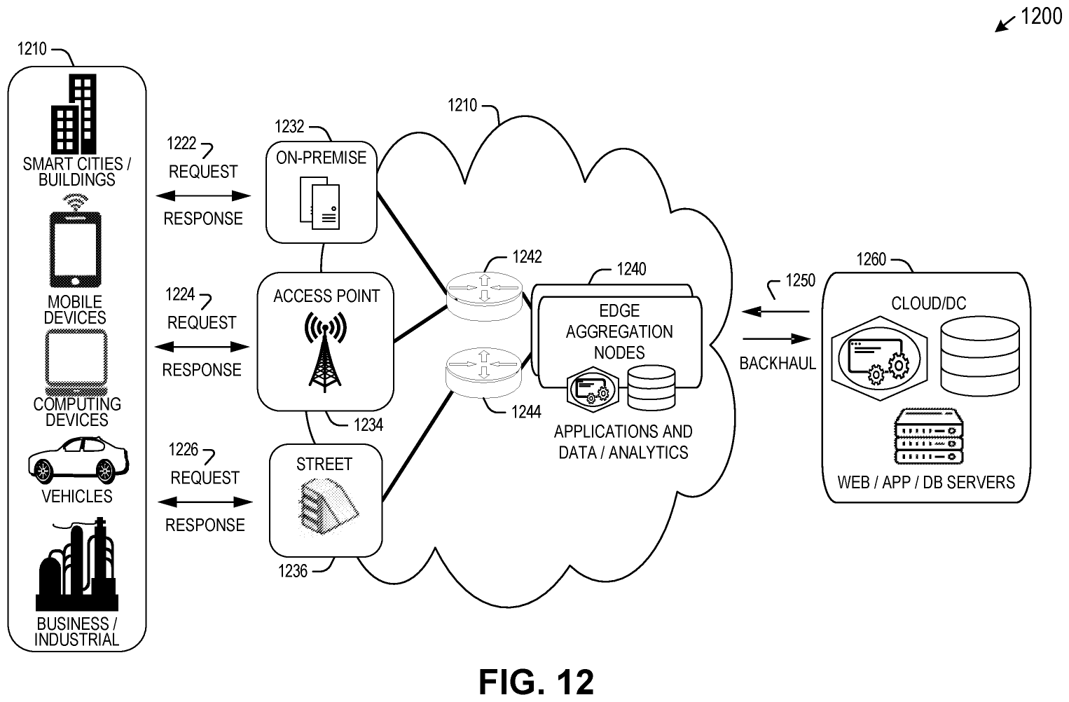

FIG. 12 illustrates an example approach for networking and services in an edge computing system, according to an embodiment. In FIG. 12, various client endpoints 1210 (in the form of mobile devices, computers, autonomous vehicles, business computing equipment, industrial processing equipment) exchange requests and responses that are specific to the type of endpoint network aggregation. For instance, client endpoints 1210 may obtain network access via a wired broadband network, by exchanging requests and responses 1222 through an on-premises network system 1232. Some client endpoints 1210, such as mobile computing devices, may obtain network access via a wireless broadband network, by exchanging requests and responses 1224 through an access point (e.g., cellular network tower) 1234. Some client endpoints 1210, such as autonomous vehicles may obtain network access for requests and responses 1226 via a wireless vehicular network through a street-located network system 1236. However, regardless of the type of network access, the TSP may deploy aggregation points 1242, 1244 within the edge cloud 1210 to aggregate traffic and requests, such as using edge cloud 1010 shown in FIG. 10 or using edge cloud 1110 shown in FIG. 11. Thus, within the edge cloud 1210, the TSP may deploy various compute and storage resources, such as at edge aggregation nodes 1240, to provide requested content. The edge aggregation nodes 1240 and other systems of the edge cloud 1210 are connected to a cloud or data center 1260, which uses a backhaul network 1250 to fulfill higher-latency requests from a cloud/data center for websites, applications, database servers, etc. Additional or consolidated instances of the edge aggregation nodes 1240 and the aggregation points 1242, 1244, including those deployed on a single server framework, may also be present within the edge cloud 1210 or other areas of the TSP infrastructure.

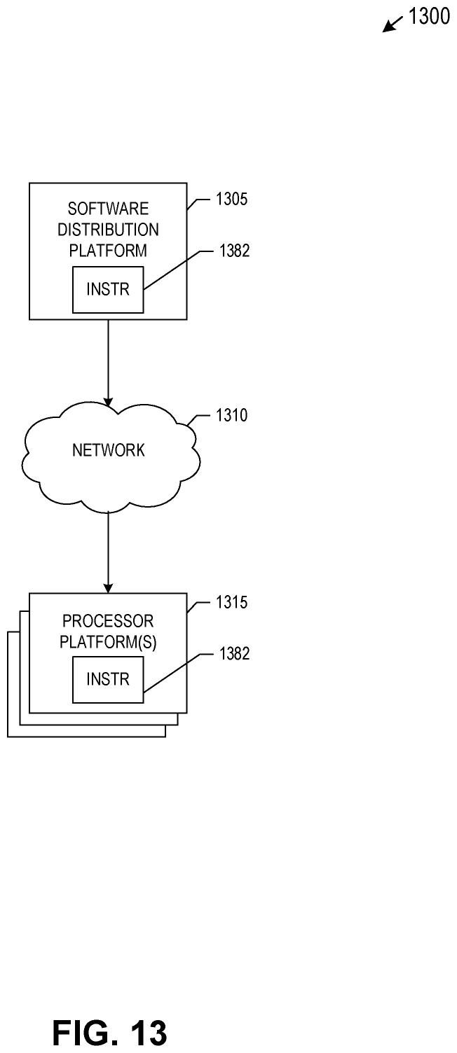

FIG. 13 illustrates an example software distribution platform 1305 to distribute software, according to an embodiment. The software distribution platform 1305 may include computer readable instructions 1382 (e.g., computer readable instructions 982 of FIG. 9B), to one or more devices, such as example processor platform(s) 1315 and/or example connected edge devices 1111 of FIG. 11. The example software distribution platform 1305 may be implemented by any computer server, data facility, cloud service, etc., capable of storing and transmitting software to other computing devices (e.g., third parties, the example connected edge devices 1111 of FIG. 11). Example connected edge devices may be customers, clients, managing devices (e.g., servers), third parties (e.g., customers of an entity owning and/or operating the software distribution platform 1305). Example connected edge devices may operate in commercial and/or home automation environments. In some examples, a third party is a developer, a seller, and/or a licensor of software such as the example computer readable instructions 1382. The third parties may be consumers, users, retailers, OEMs, etc., that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 13, the software distribution platform 1305 includes one or more servers and one or more storage devices. The storage devices store the computer readable instructions 1382, which may correspond to the example computer readable instructions 982 of FIG. 9B, as described above. The one or more servers of the example software distribution platform 1305 are in communication with a network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or via a third-party payment entity. The servers enable purchasers and/or licensors to download the computer readable instructions 982 from the software distribution platform 1305. For example, the software may be downloaded to the example processor platform(s) 1315 (e.g., example connected edge devices), which is/are to execute the computer readable instructions 1382 to implement non-dominant resource management for edge multi-tenant applications. In some examples, one or more servers of the software distribution platform 1305 are communicatively connected to one or more security domains and/or security devices through which requests and transmissions of the example computer readable instructions 1382 must pass. In some examples, one or more servers of the software distribution platform 1305 periodically offer, transmit, and/or force updates to the software (e.g., computer readable instructions 1382) to ensure improvements, patches, updates, etc., are distributed and applied to the software at the end user devices.

In the illustrated example of FIG. 13, the computer readable instructions 1382 are stored on storage devices of the software distribution platform 1305 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 982 stored in the software distribution platform 1305 are in a first format when transmitted to the example processor platform(s) 1315. In some examples, the first format is an executable binary in which particular types of the processor platform(s) 1315 can execute. However, in some examples, the first format is uncompiled code that requires one or more preparation tasks to transform the first format to a second format to enable execution on the example processor platform(s) 1315. For instance, the receiving processor platform(s) 1315 may need to compile the computer readable instructions 1382 in the first format to generate executable code in a second format that is capable of being executed on the processor platform(s) 1315. In still other examples, the first format is interpreted code that, upon reaching the processor platform(s) 1315, is interpreted by an interpreter to facilitate execution of instructions.

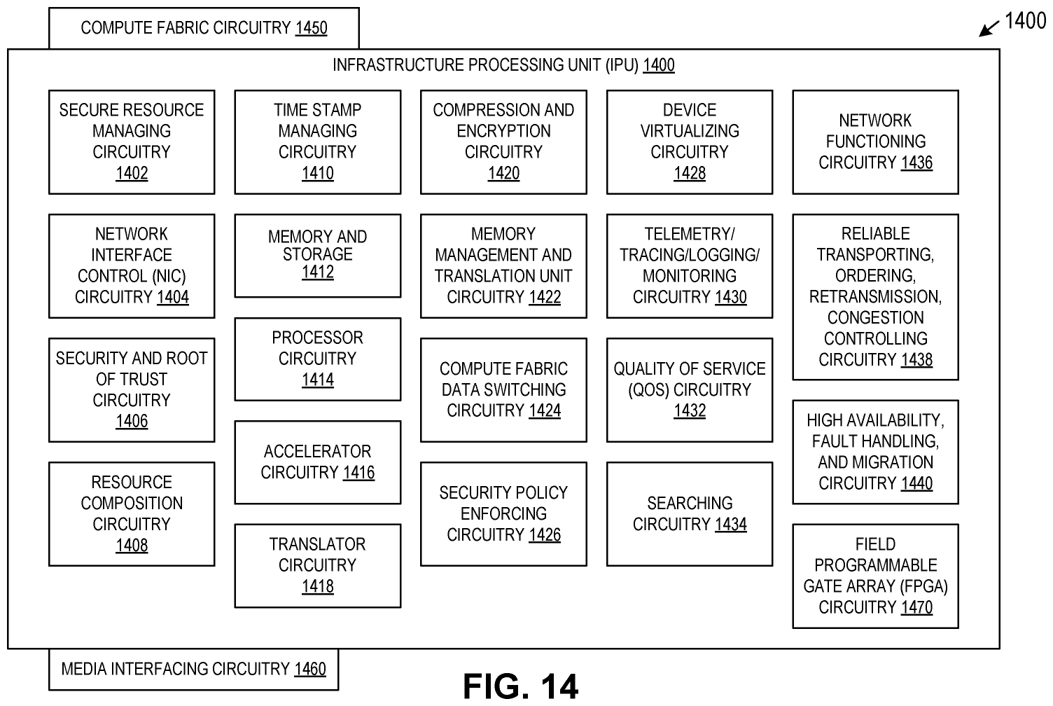

FIG. 14 depicts an example of an infrastructure processing unit (IPU). Different examples of IPUs disclosed herein enable improved performance, management, security and coordination functions between entities (e.g., cloud service providers), and enable infrastructure offload or communications coordination functions. As disclosed in further detail below, IPUs may be integrated with smart NICs and storage or memory (e.g., on a same die, system on chip (SoC), or connected dies) that are located at on-premises systems, base stations, gateways, neighborhood central offices, and so forth. Different examples of one or more IPUs disclosed herein can perform an application including any number of microservices, where each microservice runs in its own process and communicates using protocols (e.g., an HTTP resource API, message service or gRPC). Microservices can be independently deployed using centralized management of these services. A management system may be written in different programming languages and use different data storage technologies.

Furthermore, one or more IPUs can execute platform management, networking stack processing operations, security (crypto) operations, storage software, identity and key management, telemetry, logging, monitoring and service mesh (e.g., control how different microservices communicate with one another). The IPU can access an xPU to offload performance of various tasks. For instance, an IPU exposes XPU, storage, memory, and CPU resources and capabilities as a service that can be accessed by other microservices for function composition. This can improve performance and reduce data movement and latency. An IPU can perform capabilities such as those of a router, load balancer, firewall, TCP/reliable transport, a service mesh (e.g., proxy or API gateway), security, data-transformation, authentication, quality of service (QoS), security, telemetry measurement, event logging, initiating and managing data flows, data placement, or job scheduling of resources on an xPU, storage, memory, or CPU.

In the illustrated example of FIG. 14, the IPU 1400 includes or otherwise accesses secure resource managing circuitry 1402, network interface controller (NIC) circuitry 1404, security and root of trust circuitry 1406, resource composition circuitry 1408, time stamp managing circuitry 1410, memory and storage 1412, processing circuitry 1414, accelerator circuitry 1416, or translator circuitry 1418. Any number or combination of other structure(s) can be used such as but not limited to compression and encryption circuitry 1420, memory management and translation unit circuitry 1422, compute fabric data switching circuitry 1424, security policy enforcing circuitry 1426, device virtualizing circuitry 1428, telemetry, tracing, logging and monitoring circuitry 1430, quality of service circuitry 1432, searching circuitry 1434, network functioning circuitry (e.g., routing, firewall, load balancing, network address translating (NAT), etc.) 1436, reliable transporting, ordering, retransmission, congestion controlling circuitry 1438, and high availability, fault handling and migration circuitry 1440 shown in FIG. 14. Different examples can use one or more structures (components) of the example IPU 1400 together or separately. For example, compression and encryption circuitry 1420 can be used as a separate service or chained as part of a data flow with vSwitch and packet encryption.

In some examples, IPU 1400 includes a field programmable gate array (FPGA) 1470 structured to receive commands from an CPU, XPU, or application via an API and perform commands/tasks on behalf of the CPU, including workload management and offload or accelerator operations. The illustrated example of FIG. 14 may include any number of FPGAs configured or otherwise structured to perform any operations of any IPU described herein.

Example compute fabric circuitry 1450 provides connectivity to a local host or device (e.g., server or device (e.g., xPU, memory, or storage device)). Connectivity with a local host or device or smartNlC or another IPU is, in some examples, provided using one or more of peripheral component interconnect express (PCIe), ARM AXI, Intel® QuickPath Interconnect (QPI), Intel® Ultra Path Interconnect (UPI), Intel® On-Chip System Fabric (IOSF), Omnipath, Ethernet, Compute Express Link (CXL), HyperTransport, NVLink, Advanced Microcontroller Bus Architecture (AMBA) interconnect, OpenCAPI, Gen-Z, CCIX, Infinity Fabric (IF), and so forth. Different examples of the host connectivity provide symmetric memory and caching to enable equal peering between CPU, XPU, and IPU (e.g., via CXL.cache and CXL.mem).

Example media interfacing circuitry 1460 provides connectivity to a remote smartNlC or another IPU or service via a network medium or fabric. This can be provided over any type of network media (e.g., wired or wireless) and using any protocol (e.g., Ethernet, InfiniBand, Fiber channel, ATM, to name a few).

In some examples, instead of the server/CPU being the primary component managing IPU 1400, IPU 1400 is a root of a system (e.g., rack of servers or data center) and manages compute resources (e.g., CPU, xPU, storage, memory, other IPUs, and so forth) in the IPU 1400 and outside of the IPU 1400. Different operations of an IPU are described below.

In some examples, the IPU 1400 performs orchestration to decide which hardware or software is to execute a workload based on available resources (e.g., services and devices) and considers service level agreements and latencies, to determine whether resources (e.g., CPU, xPU, storage, memory, etc.) are to be allocated from the local host or from a remote host or pooled resource. In examples when the IPU 1400 is selected to perform a workload, secure resource managing circuitry 1402 offloads work to a CPU, xPU, or other device and the IPU 1400 accelerates connectivity of distributed runtimes, reduce latency, CPU and increases reliability.

In some examples, secure resource managing circuitry 1402 runs a service mesh to decide what resource is to execute workload, and provide for L7 (application layer) and remote procedure call (RPC) traffic to bypass kernel altogether so that a user space application can communicate directly with the example IPU 1400 (e.g., IPU 1400 and application can share a memory space). In some examples, a service mesh is a configurable, low-latency infrastructure layer designed to handle communication among application microservices using application programming interfaces (APIs) (e.g., over remote procedure calls (RPCs)). The example service mesh provides fast, reliable, and secure communication among containerized or virtualized application infrastructure services. The service mesh can provide critical capabilities including, but not limited to service discovery, load balancing, encryption, observability, traceability, authentication and authorization, and support for the circuit breaker pattern.

In some examples, infrastructure services include a composite node created by an IPU at or after a workload from an application is received. In some cases, the composite node includes access to hardware devices, software using APIs, RPCs, gRPCs, or communications protocols with instructions such as, but not limited, to iSCSI, NVMe-oF, or CXL.

In some cases, the example IPU 1400 dynamically selects itself to run a given workload (e.g., microservice) within a composable infrastructure including an IPU, xPU, CPU, storage, memory, and other devices in a node.

In some examples, communications transit through media interfacing circuitry 1460 of the example IPU 1400 through a NIC/smartNlC (for cross node communications) or loopback back to a local service on the same host. Communications through the example media interfacing circuitry 1460 of the example IPU 1400 to another IPU can then use shared memory support transport between xPUs switched through the local IPUs. Use of IPU-to-IPU communication can reduce latency and jitter through ingress scheduling of messages and work processing based on service level objective (SLO).

For example, for a request to a database application that requires a response, the example IPU 1400 prioritizes its processing to minimize the stalling of the requesting application. In some examples, the IPU 1400 schedules the prioritized message request issuing the event to execute a SQL query database and the example IPU constructs microservices that issue SQL queries and the queries are sent to the appropriate devices or services.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

As used in any embodiment herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

Each of the following non-limiting examples may stand on its own, or may be combined in various permutations or combinations with one or more of the other examples.

Example 1 is a system for secure and attestable functions-as-a-service, the system comprising: a first edge computing device including a first processor device and a first memory, the first memory including edge device instructions that, when executed by the first processor device, cause the first processor device to: receive a first service execution request; identify, based on the first service execution request, a first function as a service and a second function as a service; send first function instructions to a second processor device on a second edge computing device to execute the first function as a service and return a first function response; send second function instructions to a third processor device on a third edge computing device to execute the second function as a service and return a second function response; and return a service request result of the first service execution request based on the first function response and the second function response.

In Example 2, the subject matter of Example 1 includes, the edge device instructions further causing the first processor device to: identify, based on the first service execution request, a third function as a service; and execute the third function as a service at the first processor device at the first edge computing device and return a third function response; wherein the service request result is further based on the third function response.

In Example 3, the subject matter of Examples 1-2 includes, the edge device instructions further causing the first processor device to generate a first software-defined network at the first processor device based on the first service execution request, the first function as a service and the second function as a service executed at the first software-defined network.

In Example 4, the subject matter of Example 3 includes, the edge device instructions further causing the first processor device to access a function as a service chain from a first disk cache as storage in response to the first service execution request, wherein the first software-defined network is generated based on the service chain.

In Example 5, the subject matter of Examples 3-4 includes, the edge device instructions further causing the first processor device to destroy the first software-defined network in response to a first completion of the first function as a service.

In Example 6, the subject matter of Examples 3-5 includes, the edge device instructions further causing the first processor device to: receive a second computing request subsequent to a completion of the first service execution request, the second computing request including a request to execute the first function as a service and the second function as a service; attest a first security of the first software-defined network; and execute, in response to attesting the first security of the first software-defined network, the first function as a service.

In Example 7, the subject matter of Example 6 includes, the edge device instructions further causing the first processor device to determine a security attestation period has elapsed since the completion of the first service execution request, wherein attesting the first security is responsive to determining the security attestation period has elapsed.

In Example 8, the subject matter of Example 7 includes, the edge device instructions further causing the first processor device to send a first signal, in response to attesting the first security, to the second processor device to execute the second function as a service.

In Example 9, the subject matter of Examples 1-8 includes, a third processor device on the first edge computing device, the edge device instructions further causing the first processor device to: identify, based on the first service execution request, a third function as a service; and send a second signal to the third processor device to execute the third function as a service.

In Example 10, the subject matter of Examples 1-9 includes, wherein: the first function as a service generates a first intermediate result executed at the first edge computing device; the second function as a service generates a second intermediate result based on the first intermediate result; and the service request result is generated based on the second intermediate result.

In Example 11, the subject matter of Example 10 includes, the edge device instructions further causing the first processor device to: access a first security context at the first processor device; and generate a first secure network connection between the first edge computing device and the second edge computing device based on the first security context; wherein the first intermediate result is sent via the first secure network connection.

In Example 12, the subject matter of Example 11 includes, the edge device instructions further causing the first processor device to send a second security context from the second edge computing device to a second disk cache as storage subsequent to sending the first intermediate result via the first secure network connection.

In Example 13, the subject matter of Example 12 includes, wherein: the first security context is accessed from the second disk cache as storage device to the first edge computing device; and the second security context is sent from the second edge computing device to the second disk cache as storage.

In Example 14, the subject matter of Examples 1-13 includes, wherein: the first edge computing device in networked communication with a second edge computing device; the first edge computing device is in a first location; and the second edge computing device is in a second location, the second location different from the first location.

In Example 15, the subject matter of Examples 1-14 includes, wherein the first processor device includes at least one of a logical processor device and a physical processor device.

Example 16 is at least one machine-readable storage medium, comprising edge device instructions that, responsive to being executed with processor circuitry of a computer-controlled device, cause the processor circuitry to: receive a first service execution request at a first edge computing device, the first edge computing device including a first processor device and a first memory; identify, based on the first service execution request, a first function as a service and a second function as a service; send first function instructions to a second processor device on a second edge computing device to execute the first function as a service and provide a first function response; send second instructions to a third processor device on a third edge computing device to execute the second function as a service and provide a second function response; and return a service request result of the first service execution request based on the first function response and the second function response.

In Example 17, the subject matter of Example 16 includes, the edge device instructions further causing the processor circuitry to: identify, based on the first service execution request, a third function as a service; and execute the third function as a service at the first processor device at the first edge computing device and return a third function response; wherein the service request result is further based on the third function response.

In Example 18, the subject matter of Examples 16-17 includes, the edge device instructions further causing the processor circuitry to generate a first software-defined network at the first processor device based on the first service execution request, the first function as a service executed at the first software-defined network.

In Example 19, the subject matter of Example 18 includes, the edge device instructions further causing the processor circuitry to access a function as a service chain from a first disk cache as storage in response to the first service execution request, wherein the first software-defined network is generated based on the service chain.

In Example 20, the subject matter of Examples 18-19 includes, the edge device instructions further causing the processor circuitry to destroy the first software-defined network in response to a first completion of the first function as a service.

In Example 21, the subject matter of Examples 18-20 includes, the edge device instructions further causing the processor circuitry to: receive a second computing request subsequent to a completion of the first service execution request, the second computing request including a request to execute the first function as a service and the second function as a service; attest a first security of the first software-defined network; and execute, in response to attesting the first security of the first software-defined network, the first function as a service.

In Example 22, the subject matter of Example 21 includes, the edge device instructions further causing the processor circuitry to determine a security attestation period has elapsed since the completion of the first service execution request, wherein attesting the first security is responsive to determining the security attestation period has elapsed.

In Example 23, the subject matter of Example 22 includes, the edge device instructions further causing the processor circuitry to send a first signal, in response to attesting the first security, to the second processor device to execute the second function as a service.

In Example 24, the subject matter of Examples 16-23 includes, the edge device instructions further causing the processor circuitry to: identify, based on the first service execution request, a third function as a service; and send a second signal to a third processor device on the first edge computing device to execute the third function as a service.

In Example 25, the subject matter of Examples 16-24 includes, wherein: the first function as a service generates a first intermediate result executed at the first edge computing device; the second function as a service generates a second intermediate result based on the first intermediate result; and the service request result is generated based on the second intermediate result.

In Example 26, the subject matter of Example 25 includes, the edge device instructions further causing the processor circuitry to: access a first security context at the first processor device; and generate a first secure network connection between the first edge computing device and the second edge computing device based on the first security context; wherein the first intermediate result is sent via the first secure network connection.

In Example 27, the subject matter of Example 26 includes, the edge device instructions further causing the processor circuitry to send a second security context from the second edge computing device to a second disk cache as storage subsequent to sending the first intermediate result via the first secure network connection.

In Example 28, the subject matter of Example 27 includes, wherein: the first security context is accessed from the second disk cache as storage device to the first edge computing device; and the second security context is sent from the second edge computing device to the second disk cache as storage.

In Example 29, the subject matter of Examples 16-28 includes, wherein: the first edge computing device in networked communication with a second edge computing device; the first edge computing device is in a first location; and the second edge computing device is in a second location, the second location different from the first location.

In Example 30, the subject matter of Examples 16-29 includes, wherein the first processor device includes at least one of a logical processor device and a physical processor device.

Example 31 is a method for secure and attestable functions-as-a-service, the method comprising: receiving a first service execution request at a first edge computing device, the first edge computing device including a first processor device and a first memory; identifying, based on the first service execution request, a first function as a service and a second function as a service; sending first function instructions to a second processor device on a second edge computing device to execute the first function as a service and return a first function response; sending second function instructions to a third processor device on a third edge computing device to execute the second function as a service and provide a second function response; and returning a service request result of the first service execution request based on the first function response and the second function response.

In Example 32, the subject matter of Example 31 includes, identifying, based on the first service execution request, a third function as a service; and executing the third function as a service at the first processor device at the first edge computing device and return a third function response; wherein the service request result is further based on the third function response.

In Example 33, the subject matter of Examples 31-32 includes, generating a first software-defined network at the first processor device based on the first service execution request, the first function as a service executed at the first software-defined network.

In Example 34, the subject matter of Example 33 includes, paging-in a function as a service chain from a first disk cache as storage in response to the first service execution request, wherein the first software-defined network is generated based on the service chain.

In Example 35, the subject matter of Examples 33-34 includes, destroying the first software-defined network in response to a first completion of the first function as a service.

In Example 36, the subject matter of Examples 33-35 includes, receiving a second computing request subsequent to a completion of the first service execution request, the second computing request including a request to execute the first function as a service and the second function as a service; attesting a first security of the first software-defined network; and executing, in response to attesting the first security of the first software-defined network, the first function as a service.

In Example 37, the subject matter of Example 36 includes, determining a security attestation period has elapsed since the completion of the first service execution request, wherein attesting the first security is responsive to determining a security attestation period has elapsed.

In Example 38, the subject matter of Example 37 includes, sending a first signal, in response to attesting the first security, to the second processor device to execute the second function as a service.

In Example 39, the subject matter of Examples 31-38 includes, identifying, based on the first service execution request, a third function as a service; and sending a second signal to a third processor device on the first edge computing device to execute the third function as a service.

In Example 40, the subject matter of Examples 31-39 includes, wherein: the first function as a service generates a first intermediate result executed at the first edge computing device; the second function as a service generates a second intermediate result based on the first intermediate result; and the service request result is generated based on the second intermediate result.

In Example 41, the subject matter of Example 40 includes, paging-in a first security context at the first processor device; and generating a first secure network connection between the first edge computing device and the second edge computing device based on the first security context; wherein the first intermediate result is sent via the first secure network connection.

In Example 42, the subject matter of Example 41 includes, paging-out a second security context from the second edge computing device subsequent to sending the first intermediate result via the first secure network connection.

In Example 43, the subject matter of Example 42 includes, wherein: the first security context is accessed from a second disk cache as storage device to the first edge computing device; and the second security context is sent from the second edge computing device to the second disk cache as storage.

In Example 44, the subject matter of Examples 31-43 includes, wherein: the first edge computing device in networked communication with a second edge computing device; the first edge computing device is in a first location; and the second edge computing device is in a second location, the second location different from the first location.

In Example 45, the subject matter of Examples 31-44 includes, wherein the first processor device includes at least one of a logical processor device and a physical processor device.

Example 46 is a first edge computing device comprising: a first processor device; and a first memory, the first memory including edge device instructions that, when executed by the first processor device, cause the first processor device to: receive a first service execution request; identify, based on the first service execution request, a first function as a service and a second function as a service; execute the first function as a service at the first processor device; send second instructions to a second processor device on a second edge computing device to execute the second function as a service and provide a response; and return a service request result of the first service execution request based on the response.

Example 47 is at least one machine-readable medium including instructions that, when executed by processing circuitry, cause the processing circuitry to perform operations to implement of any of Examples 1-46.

Example 48 is an apparatus comprising means to implement of any of Examples 1-46.

Example 49 is a system to implement of any of Examples 1-46.

Example 50 is a method to implement of any of Examples 1-46.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for secure and attestable functions-as-a-service, the system comprising:
a first edge computing device including a first processor device and a first memory, the first memory including edge device instructions that, when executed by the first processor device, cause the first processor device to:
receive a first service execution request;
identify, based on the first service execution request, a first function as a service and a second function as a service;
send first function instructions to a second processor device on a second edge computing device to execute the first function as a service and return a first function response;
send second function instructions to a third processor device on a third edge computing device to execute the second function as a service and return a second function response; and
return a service request result of the first service execution request based on the first function response and the second function response.

2. The system of claim 1, the edge device instructions further causing the first processor device to:
identify, based on the first service execution request, a third function as a service; and
execute the third function as a service at the first processor device at the first edge computing device and return a third function response;
wherein the service request result is further based on the third function response.

3. The system of claim 1, the edge device instructions further causing the first processor device to generate a first software-defined network at the first processor device based on the first service execution request, the first function as a service and the second function as a service executed at the first software-defined network.

4. The system of claim 3, the edge device instructions further causing the first processor device to access a function as a service chain from a first disk cache as storage in response to the first service execution request, wherein the first software-defined network is generated based on the service chain.

5. The system of claim 3, the edge device instructions further causing the first processor device to destroy the first software-defined network in response to a first completion of the first function as a service.

6. The system of claim 3, the edge device instructions further causing the first processor device to:
receive a second computing request subsequent to a completion of the first service execution request, the second computing request including a request to execute the first function as a service and the second function as a service;
attest a first security of the first software-defined network; and
execute, in response to attesting the first security of the first software-defined network, the first function as a service.

7. The system of claim 6, the edge device instructions further causing the first processor device to determine a security attestation period has elapsed since the completion of the first service execution request, wherein attesting the first security is responsive to determining the security attestation period has elapsed.

8. The system of claim 7, the edge device instructions further causing the first processor device to send a first signal, in response to attesting the first security, to the second processor device to execute the second function as a service.

9. The system of claim 1, further including a third processor device on the first edge computing device, the edge device instructions further causing the first processor device to:
identify, based on the first service execution request, a third function as a service; and
send a second signal to the third processor device to execute the third function as a service.

10. The system of claim 1, wherein:
the first function as a service generates a first intermediate result executed at the first edge computing device;
the second function as a service generates a second intermediate result based on the first intermediate result; and
the service request result is generated based on the second intermediate result.

11. The system of claim 10, the edge device instructions further causing the first processor device to:
access a first security context at the first processor device; and
generate a first secure network connection between the first edge computing device and the second edge computing device based on the first security context;
wherein the first intermediate result is sent via the first secure network connection.

12. The system of claim 11, the edge device instructions further causing the first processor device to send a second security context from the second edge computing device to a second disk cache as storage subsequent to sending the first intermediate result via the first secure network connection.

13. At least one machine-readable storage medium, comprising edge device instructions that, responsive to being executed with processor circuitry of a computer-controlled device, cause the processor circuitry to:
receive a first service execution request at a first edge computing device, the first edge computing device including a first processor device and a first memory;
identify, based on the first service execution request, a first function as a service and a second function as a service;
send first function instructions to a second processor device on a second edge computing device to execute the first function as a service and provide a first function response;
send second instructions to a third processor device on a third edge computing device to execute the second function as a service and provide a second function response; and
return a service request result of the first service execution request based on the first function response and the second function response.

14. The at least one machine-readable storage medium of claim 13, the edge device instructions further causing the processor circuitry to:
identify, based on the first service execution request, a third function as a service; and
execute the third function as a service at the first processor device at the first edge computing device and return a third function response;
wherein the service request result is further based on the third function response.

15. The at least one machine-readable storage medium of claim 13, the edge device instructions further causing the processor circuitry to generate a first software-defined network at the first processor device based on the first service execution request, the first function as a service executed at the first software-defined network.

16. The at least one machine-readable storage medium of claim 15, the edge device instructions further causing the processor circuitry to access a function as a service chain from a first disk cache as storage in response to the first service execution request, wherein the first software-defined network is generated based on the service chain.

17. A method for secure and attestable functions-as-a-service, the method comprising:
receiving a first service execution request at a first edge computing device, the first edge computing device including a first processor device and a first memory;
identifying, based on the first service execution request, a first function as a service and a second function as a service;
sending first function instructions to a second processor device on a second edge computing device to execute the first function as a service and return a first function response;
sending second function instructions to a third processor device on a third edge computing device to execute the second function as a service and provide a second function response; and
returning a service request result of the first service execution request based on the first function response and the second function response.

18. The method of claim 17, further including:
identifying, based on the first service execution request, a third function as a service; and
executing the third function as a service at the first processor device at the first edge computing device and return a third function response;
wherein the service request result is further based on the third function response.

19. The method of claim 17, further including generating a first software-defined network at the first processor device based on the first service execution request, the first function as a service executed at the first software-defined network.

20. The method of claim 19, further including:
receiving a second computing request subsequent to a completion of the first service execution request, the second computing request including a request to execute the first function as a service and the second function as a service;
attesting a first security of the first software-defined network; and
executing, in response to attesting the first security of the first software-defined network, the first function as a service.
